(19) United States
(12) Patent Application Publication
(10) Pub. No.: US 2026/0003216 A1
(43) Pub. Date: Jan. 1, 2026

(54) OPTICAL MODULATOR INTEGRATED SEMICONDUCTOR LASER, OPTICAL MODULE, MULTI-LEVEL INTENSITY MODULATION TRANSCEIVER, AND OPTICAL LINE TERMINATING DEVICE

(71) Applicant: Mitsubishi Electric Corporation, Tokyo (JP)

(72) Inventors: Eitaro ISHIMURA, Tokyo (JP); Kyosuke KURAMOTO, Tokyo (JP); Asami UCHIYAMA, Tokyo (JP)

(73) Assignee: Mitsubishi Electric Corporation, Tokyo (JP)

(21) Appl. No.: 19/183,754

(22) Filed: Apr. 18, 2025

(30) Foreign Application Priority Data
Jun. 26, 2024 (JP) 2024-102539

(51) Int. Cl. G02F 1/015; G02F 1/025

(52) U.S. Cl. CPC G02F 1/0157; G02F 1/025

(57) ABSTRACT

An optical modulator integrated semiconductor laser of the present disclosure includes: a semiconductor laser section; a first connecting waveguide section; a first EA modulator section; a second connecting waveguide section; a second EA modulator section; and a first common electrode electrically connecting an n-type electrode of a first EA modulator provided in the first EA modulator section and a p-type electrode of a second EA modulator provided in the second EA modulator section.

### BACKGROUND OF THE DISCLOSURE

### 1. Field of the Disclosure

The present disclosure relates to an optical modulator integrated semiconductor laser, an optical module, a multi-level intensity modulation transceiver, and an optical line terminating device.

### 2. Description of the Background Art

Along with the progress of digital transformation utilizing digital information, the development of communication networks for exchanging digital information and data centers for storing and processing data has been remarkable. Optical communication is used for communication networks and data center communications, and remarkable progress has been made in recent years in terms of high-speed and high-capacity communication.

In communication networks and data centers, on the transmitting side of optical communication, an EA modulator integrated semiconductor laser (EML), which is a kind of an optical modulator integrated semiconductor laser, is used as a light source. The EA modulator integrated semiconductor laser is a device that integrates an electro-absorption (EA) modulator, which excels in high-speed performance, and a laser diode (LD) on a single chip.

In the EA modulator integrated semiconductor laser, laser light emitted from the semiconductor laser is modulated by the EA modulator, by extinguishing (absorbing) or transmitting the light so as to correspond to the digital signals zero and one. The laser light modulated by the EA modulator enables high-speed modulation compared to the method of directly modulating the current of the semiconductor laser, and also enables long-distance transmission because the wavelength spectrum spread during optical modulation is small.

In recent years, the EA modulator integrated semiconductor laser has become the most important optical device for high-speed communication over 25 Gbit/sec. In particular, high symbol rate optical transmission exceeding 50 Gbaud is carried out using the PAM4 (Pulse Amplitude Modulation four-level) system in data centers. Note that one Gbaud means one billion pulses per one second.

In the EA modulator, multiple quantum well layers (MOWs) are mainly used as layers (Hereinafter referred to as modulation layer) that modulate light intensity by absorption of light. When an electric field is applied to an MOW layer, which is an i-type layer, by applying a reverse voltage to a p-i-n junction sandwiched between a p-type semiconductor layer and an n-type semiconductor layer, the wavelength of the light absorption edge of the MQW layer shifts toward a longer wavelength. This phenomenon is called the quantum-confined Stark effect. The phenomenon of the optical absorption coefficient changing due to the shift in the wavelength of the light absorption edge caused by the application of an electric field is used to modulate the light (See, for example, Non-Patent Document 1).
Patent Document 1: Japanese Patent No. 4698888
Patent Document 2: Japanese Patent No. 4017352
Patent Document 3: Japanese Patent No. 3591447
Patent Document 4: Japanese Patent No. 5573386
Non-Patent Document 1: THOMAS H. WOOD, “Multiple Quantum Well (MQW) Waveguide Modulators” JOURNAL OF LIGHTWAVE TECHNOLOGY, VOL. 6, NO. 6, pp. 743-757 (1988)

Problems related to electromagnetic interference in EA modulator integrated semiconductor lasers will be explained below. For example, in the EA modulator integrated semiconductor laser used in the PAM4 transceiver, DC current of about +100 mA is supplied to the LD, and DC bias of about −1 V and signal voltage of 1 Vpp (Peak to Peak Voltage) are applied to the EA modulator for driving.

In the PAM4 transceiver, multiple EA modulator integrated semiconductor lasers with different laser wavelengths are mounted close to each other to perform wavelength multiplexed communication. In recent years, in order to respond to the demand for miniaturization of transceivers, a configuration has been required in which multiple EA modulator integrated semiconductor lasers are mounted in parallel at a narrow pitch of about 1 mm, for example, four or more EA modulator integrated semiconductor lasers are mounted at a pitch of about 1 mm.

Meanwhile, in order to respond to high-capacity communication, a voltage modulation signal with a modulation speed of 50 Gbaud or more is applied to the EA modulator as described above. As shown in the schematic diagram of the comparative example (FIG. 2A) below, the high-frequency modulation signal applied to the EA modulator integrated semiconductor laser is applied to the EA modulator through a power line including signal lines, wires, etc., and electromagnetic waves are radiated in this process. The semiconductor laser is also electrically connected to the LD current line through wires, etc., but the wires are particularly susceptible to electromagnetic interference. When the semiconductor laser is affected by electromagnetic interference, there is a problem that the laser light intensity is modulated at high frequencies, causing intensity noise.

In addition, when electromagnetic waves generated from adjacent EA modulator integrated semiconductor lasers are coupled to the EA modulator, potential blur due to electromagnetic interference occurs and the trace line of the electric modulation waveform becomes thick as shown in the schematic diagram of the electric modulation waveform (FIG. 2B), which explains the comparative example described later. As a result, as shown in the schematic diagram of the optical modulation waveform (FIG. 2C) described later, there is a problem that the quality of the optical waveform deteriorates and the error rate increases. In addition, there is a problem that electromagnetic interference occurs with adjacent EA modulator drivers and with photodetectors.

In the future, as generative AI develops, the amount of data center communication processing is expected to increase even further, and it is expected that many transceivers will be used. However, as the bandwidth increases, the amount of electromagnetic interference also increases, and due to the influence of the electromagnetic interference described above, there are now limits to the high-density mounting and broadband communication speeds of EA modulator integrated semiconductor lasers, and solving the problems caused by electromagnetic interference has become a major issue. Currently, higher speeds of 100 to 200 Gbaud or more are also required for EA modulator integrated semiconductor lasers. However, in this case, the cutoff frequency of the EA modulator needs to be 100 GHz or more, resulting in an increasing trend in the influence of electromagnetic interference.

### SUMMARY OF THE DISCLOSURE

The present disclosure has been made to solve the above problems, and an object of the present disclosure is to achieve high-density multi-element mounting and large-capacity communication of an optical modulator integrated semiconductor laser by enabling reduction of electromagnetic interference and broadening of the bandwidth of the optical modulator integrated semiconductor laser.

An optical modulator integrated semiconductor laser according to the present disclosure includes:
a semi-insulating substrate;
a semiconductor laser section formed on the semi-insulating substrate and including at least an n-type cladding layer, an active layer, and a p-type cladding layer;
a first connecting waveguide section formed on the semi-insulating substrate and including at least a first lower cladding layer, a first waveguide layer, and a first upper cladding layer;
a first EA modulator section formed on the semi-insulating substrate and including at least an n-type first semiconductor layer, a first modulation layer, a p-type first semiconductor layer, an n-type electrode of a first EA modulator electrically connected to the n-type first semiconductor layer, and a p-type electrode of the first EA modulator electrically connected to the p-type first semiconductor layer;
a second connecting waveguide section formed on the semi-insulating substrate and including at least a second lower cladding layer, a second waveguide layer, and a second upper cladding layer;
a second EA modulator section formed on the semi-insulating substrate and including at least an n-type second semiconductor layer, a second modulation layer, a p-type second semiconductor layer, an n-type electrode of a second EA modulator electrically connected to the n-type second semiconductor layer, and a p-type electrode of the second EA modulator electrically connected to the p-type second semiconductor layer; and
a first common electrode electrically connected to the n-type electrode of the first EA modulator and the p-type electrode of the second EA modulator.

An optical module according to the present disclosure includes:
a mounting substrate;
the above-mentioned optical modulator integrated semiconductor laser that is located on the mounting substrate;
a first modulation signal line provided on the mounting substrate and electrically connected to the wire bonding pad for the p-type electrode of the first EA modulator through a wire; and
a second modulation signal line provided on the mounting substrate and electrically connected to the wire bonding pad for the n-type electrode of the second EA modulator through a wire, wherein
the first modulation signal line and the second modulation signal line are arranged on the same side as the wire bonding pad for the p-type electrode of the first EA modulator and the wire bonding pad for the n-type electrode of the second EA modulator with respect to a reference line along the center of the optical modulator integrated semiconductor laser with respect to the optical modulator integrated semiconductor laser as a reference.

A multi-level intensity modulation transceiver according to the present disclosure includes:
a digital signal processing circuit for generating a multi-level intensity modulated digital signal on a basis of an input data signal;
an analog-to-digital conversion circuit for converting the digital signal into an analog modulation signal;
an amplifier circuit for amplifying the analog modulation signal;
the above-mentioned optical modulator integrated semiconductor laser for inputting the amplified analog modulation signal; and
an optical system for coupling a modulation signal emitted from the optical modulator integrated semiconductor laser to an optical fiber.

An optical line terminating device according to the present disclosure includes:
a forward error correction circuit for correcting a data error on a basis of an input data signal;
an amplifier circuit for amplifying an electric signal;
the above-mentioned optical modulator integrated semiconductor laser for receiving the amplified electric signal; and
an optical system for coupling a modulation signal emitted from the optical modulator integrated semiconductor laser to an optical fiber.

According to the optical modulator integrated semiconductor laser of the present disclosure, even when a plurality of optical modulator integrated semiconductor lasers are arranged close to each other, electromagnetic interference from the EA modulator to the LD current line and adjacent EA modulators can be reduced, thus providing an effect of enabling high-density mounting of the optical modulator integrated semiconductor lasers. Furthermore, since two EA modulators are integrated into a single device, a doubling of extinction ratio is achieved, thus shortening the length of each EA modulator, that is, reducing capacitance of each EA modulator, thus providing an effect of achieving an optical modulator integrated semiconductor laser that can be used for high-density mounting and broadband modulation.

According to the optical module of the present disclosure, even when a plurality of optical modulator integrated semiconductor lasers are arranged close to each other, electromagnetic interference from the EA modulator to the LD current line and adjacent EA modulators can be reduced, thus providing an effect of enabling high-density mounting of the optical modulator integrated semiconductor laser in the optical module. Furthermore, since two EA modulators are integrated into a single device, a doubling of extinction ratio is achieved, thus shortening the length of each EA modulator, that is, reducing capacitance of each EA modulator, thus providing an effect of achieving an optical module that mounts an optical modulator integrated semiconductor laser that can be used for high-density mounting and broadband modulation.

According to the multi-level intensity modulation transceiver of the present disclosure, the optical modulator integrated semiconductor laser of the present disclosure is used as a light source, thereby electromagnetic interference can be reduced, thus providing an effect of achieving a multi-level intensity modulation transceiver with reduced electromagnetic interference, broadband modulation, and excellent high-density mounting.

According to the optical line terminating device of the present disclosure, the optical modulator integrated semiconductor laser of the present disclosure is used as a light source, thereby electromagnetic interference can be reduced, thus providing an effect of achieving an optical line terminating device with reduced electromagnetic interference, broadband modulation, and excellent high-density mounting.

### BRIEF DESCRIPTION OF THE DRAWINGS

FIG. 1 is a cross-sectional view showing the device structure of an optical modulator integrated semiconductor laser according to Embodiment 1;

FIG. 2A is a cross-sectional view showing a single-phase driven optical modulator integrated semiconductor laser as a comparative example;

FIG. 2B is a schematic diagram showing the electric modulation waveform of the single-phase driven optical modulator integrated semiconductor laser as a comparative example;

FIG. 2C is a schematic diagram showing the electric modulation waveform of the single-phase driven optical modulator integrated semiconductor laser as a comparative example;

FIG. 3 is a cross-sectional view showing a differential driven optical modulator integrated semiconductor laser as a comparative example;

FIG. 4A is a schematic diagram explaining the action of the optical modulator integrated semiconductor laser according to Embodiment 1;

FIG. 4B is a schematic diagram showing the electric modulation waveform of the optical modulator integrated semiconductor laser according to Embodiment 1;

FIG. 4C is a schematic diagram showing the optical modulation waveform after passing through the EA modulator of the optical modulator integrated semiconductor laser according to Embodiment 1;

FIG. 5A is a cross-sectional view of an EA modulator of a comparative example for explaining the difference from the single-phase driven optical modulator integrated semiconductor laser as a comparative example;

FIG. 5B is a cross-sectional view of the optical modulator integrated semiconductor laser according to Embodiment 1 for explaining the difference from the single-phase driven optical modulator integrated semiconductor laser as a comparative example;

FIG. 6 is a cross-sectional view of an optical modulator integrated semiconductor laser according to Modification of Embodiment 1;

FIG. 7A is a cross-sectional view parallel to the optical waveguide direction and a top view of an optical modulator integrated semiconductor laser according to Embodiment 2;

FIG. 7B is a cross-sectional view of a semiconductor laser section in a direction perpendicular to the optical waveguide direction in the optical modulator integrated semiconductor laser according to Embodiment 2;

FIG. 7C is a cross-sectional view of a first connecting waveguide section in a direction perpendicular to the optical waveguide direction in the optical modulator integrated semiconductor laser according to Embodiment 2;

FIG. 7D is a cross-sectional view of a first EA modulator section in a direction perpendicular to the optical waveguide direction in the optical modulator integrated semiconductor laser according to Embodiment 2;

FIG. 7E is a cross-sectional view of a second EA modulator section in a direction perpendicular to the optical waveguide direction in the optical modulator integrated semiconductor laser according to Embodiment 2;

FIG. 8A is a schematic diagram for explaining the action of the optical modulator integrated semiconductor laser according to Embodiment 2;

FIG. 8B is a cross-sectional view of a second EA modulator section composed of a high-mesa waveguide in a direction perpendicular to the optical waveguide direction in the optical modulator integrated semiconductor laser according to Embodiment 2;

FIG. 8C is a cross-sectional view of the second EA modulator section composed of a low-mesa waveguide in a direction perpendicular to the optical waveguide direction in the optical modulator integrated semiconductor laser according to Embodiment 2;

FIG. 8D is a cross-sectional view showing the configuration of a comparative example in which a buried waveguide is applied to the second EA modulator section;

FIG. 9A is a top view after mounting of an optical modulator integrated semiconductor laser in an optical module according to Embodiment 3;

FIG. 9B is a top view showing an example of the configuration of a transceiver to which an optical module according to Embodiment 3 is applied;

FIG. 9C is a top view after mounting of an optical modulator integrated semiconductor laser in the optical module according to Embodiment 3;

FIG. 10 is a top view after mounting of an optical modulator integrated semiconductor laser in an optical module according to Modification 1 of Embodiment 3;

FIG. 11 is a top view after mounting of an optical modulator integrated semiconductor laser in an optical module according to Modification 2 of Embodiment 3;

FIG. 12 is a top view after mounting of an optical modulator integrated semiconductor laser in an optical module according to Modification 3 of Embodiment 3;

FIG. 13A is a schematic diagram for explaining the flow of photocurrent when a first common electrode is grounded in the operation of the optical modulator integrated semiconductor laser mounted in the optical module according to Modification 3 of Embodiment 3;

FIG. 13B is a schematic diagram for explaining the flow of photocurrent when the first common electrode is not grounded in the operation of the optical modulator integrated semiconductor laser mounted in the optical module according to Modification 3 of Embodiment 3;

FIG. 13C is a schematic diagram for explaining the flow of photocurrent when the first common electrode is grounded through a capacitor in the operation of the optical modulator integrated semiconductor laser mounted in the optical module according to Modification 3 of Embodiment 3;

FIG. 14A is a top view after mounting an optical modulator integrated semiconductor laser in an optical module according to Modification 4 of Embodiment 3;

FIG. 14B is a top view after mounting the optical modulator integrated semiconductor laser in the optical module according to Modification 4 of Embodiment 3;

FIG. 15 is a top view showing an optical module configuration in which only a terminating resistor portion of the optical module shown in FIGS. 14A and 14B is changed in the optical module according to Modification 4 of Embodiment 3;

FIG. 16 is a top view showing an optical module configuration in which only a terminating resistor portion of the optical module structure shown in FIG. 15 is changed in the optical module according to Modification 4 of Embodiment 3;

FIG. 17 is a schematic diagram showing the configuration of a multi-level intensity modulation transceiver according to Embodiment 4;

FIG. 18 is a conceptual diagram showing the received waveform of the multi-level intensity modulation transceiver according to Embodiment 4;

FIG. 19 is a conceptual diagram showing the wavelength dependence of the optical absorption coefficient when a voltage is applied to an MQW layer of an optical modulator integrated semiconductor laser;

FIG. 20 is a schematic diagram showing the configuration of an OLT in an optical line terminating device of a 50G-PON system according to Embodiment 5;

FIG. 21 is a schematic diagram showing the configuration of an ONU in the optical line terminating device of the 50G-PON system according to Embodiment 5;

FIG. 22 is a cross-sectional view showing the device structure of an optical modulator integrated semiconductor laser according to Embodiment 6;

FIG. 23 is a schematic diagram showing the extinction waveforms of each EA modulator of the optical modulator integrated semiconductor laser according to Embodiment 6;

FIG. 24 is a schematic diagram showing the frequency response of each EA modulator of the optical modulator integrated semiconductor laser of Embodiment 6.

### DETAILED DESCRIPTION OF THE PREFERRED EMBODIMENTS OF THE DISCLOSURE

### Embodiment 1

### <Device Structure of Optical Modulator Integrated Semiconductor Laser According to Embodiment 1>

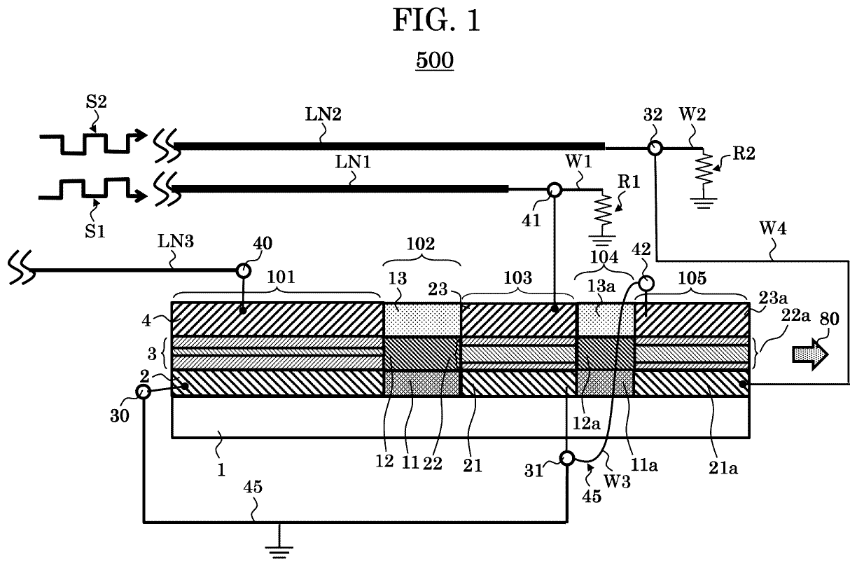

FIG. 1 is a cross-sectional view showing the device structure of an optical modulator integrated semiconductor laser 500 according to Embodiment 1. FIG. 1 also shows the state of the wiring to the optical modulator integrated semiconductor laser 500.

As shown in FIG. 1, the optical modulator integrated semiconductor laser 500 according to Embodiment 1 comprises a semiconductor laser section 101 comprising a DFB (Distributed FeedBack) laser, a first connecting waveguide section 102, a first EA modulator section 103, a second connecting waveguide section 104, and a second EA modulator section 105, which are connected sequentially along the optical waveguide direction on a semi-insulating substrate 1. The section from the semiconductor laser section 101 to the second EA modulator section 105 is collectively referred to as the optical waveguide section.

The semiconductor laser section 101 comprising the DFB laser includes: an n-type cladding layer 2 (n-type semiconductor layer) having a carrier concentration of 0.5×10¹⁸ to 8×10¹⁸ cm⁻³ and a thickness of 0.1 to 5.0 μm; an active layer 3; and a p-type cladding layer 4 (p-type semiconductor layer) having a carrier concentration of 0.5×10¹⁸ to 8×10¹⁸ cm⁻³ and a thickness of 0.1 to 5.0 μm; which are sequentially formed above a semi-insulating substrate 1 such as an Fe-doped InP substrate, a p-type electrode 40 of the semiconductor laser section electrically connected to the p-type cladding layer 4 of the semiconductor laser section 101; and an n-type electrode 30 of the semiconductor laser section electrically connected to the n-type cladding layer 2 of the semiconductor laser section 101.

The active layer 3 includes a diffraction grating layer, a multiple quantum well layer, and optical confinement layers formed on the upper and lower surfaces of the multiple quantum well layers, respectively (both not shown). The total thickness of the active layer 3 is 100 to 500 nm.

The first connecting waveguide section 102, in which a waveguide is connected to the semiconductor laser section 101, includes: an i-type first lower cladding layer 11 having a carrier concentration of 5×10¹⁷ cm⁻³ or less and a thickness of 0.1 to 5.0 μm; an i-type first waveguide layer 12 having a carrier concentration of 5×10¹⁷ cm⁻³ or less and a thickness of 50 to 500 nm and a refractive index higher than that of the cladding layer; and an i-type first upper cladding layer 13 having a carrier concentration of 5×10¹⁷ cm⁻³ or less and a thickness of 0.1 to 5.0 μm, which are sequentially formed above the semi-insulating substrate 1.

The i-type first lower cladding layer 11, the i-type first waveguide layer 12, and the i-type first upper cladding layer 13 of the first connecting waveguide section 102 may be p-type or n-type with a carrier concentration of 5×10¹⁸ cm⁻³ or less, because an isolation resistance between the semiconductor laser section 101 and the first EA modulator section 103 is high in the case where the waveguide width is 2 μm or less. Setting the isolation resistance between the semiconductor laser section 101 and the first EA modulator section 103 to 500Ω or more, which is 10 times or more higher than the impedance of 50Ω during EA modulator drive, can prevent high-frequency leakage from the first EA modulator section 103 to the semiconductor laser section 101.

The first EA modulator section 103, which is connected to the first connecting waveguide section 102, includes: an n-type first semiconductor layer 21 having a carrier concentration of 0.5×10¹⁸ to 8×10¹⁸ cm⁻³ and a thickness of 0.1 to 5.0 μm; a first modulation layer 22; a p-type first semiconductor layer 23 having a carrier concentration of 0.5×10¹⁸ to 8×10¹⁸ cm⁻³ and a thickness of 0.1 to 5.0 μm; which are sequentially formed above the semi-insulating substrate 1, a p-type electrode 41 of the first EA modulator electrically connected to the p-type first semiconductor layer 23 of the first EA modulator section 103; and an n-type electrode 31 of the first EA modulator electrically connected to the n-type first semiconductor layer 21.

The first modulation layer 22 of the first EA modulator section 103 comprises an i-type multiple quantum well layer having a carrier concentration of 5×10¹⁷ cm⁻³ or less and optical confinement layers formed above and below the multiple quantum well layer (both not shown). The total thickness of the first modulation layer 22 is 50 to 500 nm.

The second connecting waveguide section 104, in which a waveguide is connected to the first EA modulator section 103, includes: an i-type second lower cladding layer 11a having a carrier concentration of 5×10¹⁷ cm⁻³ or less and a thickness of 0.1 to 5.0 μm; an i-type second waveguide layer 12a having a carrier concentration of 5×10¹⁷ cm⁻³ or less and a thickness of 50 to 500 nm and a refractive index higher than that of the cladding layer; and an i-type second upper cladding layer 13a having a carrier concentration of 5×10¹⁷ cm⁻³ or less and a thickness of 0.1 to 5.0 μm, which are sequentially formed above the semi-insulating substrate 1.

The i-type second lower cladding layer 11a, the i-type second waveguide layer 12a, and the i-type second upper cladding layer 13a may be p-type or n-type with a carrier concentration of 5×10¹⁸ cm⁻³ or less, because the isolation resistance between the first EA modulator section 103 and the second EA modulator section 105 becomes high in the case where the waveguide width is 2 μm or less. Setting the isolation resistance between the first EA modulator section 103 and the second EA modulator section 105 to 500Ω or more, which is 10 times or more higher than the impedance of 50Ω during EA modulator drive, can prevent high-frequency leakage from the second EA modulator section 105 to the first EA modulator section 103.

The second EA modulator section 105 connected to the second connecting waveguide section 104 includes: an n-type second semiconductor layer 21a having a carrier concentration of 0.5×10¹⁸ to 8×10¹⁸ cm⁻³ and a thickness of 0.1 to 5.0 μm; a second modulation layer 22a, a p-type second semiconductor layer 23a having a carrier concentration of 0.5×10¹⁸ to 8×10¹⁸ cm⁻³ and a thickness of 0.1 to 5.0 μm; which are sequentially formed above the semi-insulating substrate 1, a p-type electrode 42 of the second EA modulator electrically connected to the p-type second semiconductor layer 23a of the second EA modulator section 105; and an n-type electrode 32 of the second EA modulator electrically connected to the n-type second semiconductor layer 21a.

The second modulation layer 22a of the second EA modulator section 105 comprises an i-type multiple quantum well layer having a carrier concentration of 5×10¹⁷ cm⁻³ or less, and optical confinement layers formed above and below the multiple quantum well layer (both not shown). The total thickness of the second modulation layer 22a is 50 to 500 nm.

The n-type electrode 31 of the first EA modulator of the first EA modulator section 103 and the p-type electrode 42 of the second EA modulator of the second EA modulator section 105 are electrically connected by an electrode or wire wiring. In the present disclosure, an electrode pattern or wire wiring that electrically connects the n-type electrode 31 of the first EA modulator and the p-type electrode 42 of the second EA modulator is referred to as a first common electrode 45. In the example shown in FIG. 1, the first common electrode 45 is electrically connected to the ground and the n-type electrode 30 of the semiconductor laser section 101. However, the first common electrode 45 is not necessarily connected to either or both of the ground and the n-type electrode 30 of the semiconductor laser section.

The first modulation signal line LN1 for transmitting the first modulation signal S1 for modulating the first EA modulator section 103 is electrically connected to the p-type electrode 41 of the first EA modulator of the first EA modulator section 103. The second modulation signal line LN2 for transmitting the second modulation signal S2 for modulating the second EA modulator section 105 is electrically connected to the n-type electrode 32 of the second EA modulator of the second EA modulator section 105. Since the first modulation signal line LN1 and the second modulation signal line LN2 are arranged close to each other in parallel, electromagnetic fields are coupled to each other.

The first modulation signal line LN1 and the second modulation signal line LN2 are electrically connected to drivers (not shown) that output a modulation signal, respectively. The first modulation signal S1 and the second modulation signal S2, which transmit the first modulation signal line LN1 and the second modulation signal line LN2, respectively, are modulated as signals of opposite phases, such as a positive-phase signal and a negative-phase signal. A DC current is supplied to the semiconductor laser section 101 through the semiconductor laser section current line LN3.

### <Operation of Optical Modulator Integrated Semiconductor Laser According to Embodiment 1>

The operation of the optical modulator integrated semiconductor laser 500 according to Embodiment 1 will be described below on the basis of FIG. 1. The DC current is injected from the semiconductor laser section current line LN3 into the semiconductor laser section 101, thereby the DFB laser constituting the semiconductor laser section 101 emits light. The light emitted from the semiconductor laser section 101 passes through the first connecting waveguide section 102 and reaches the first EA modulator section 103.

The first modulation signal S1, that is, the modulated voltage signal, is input from the first modulation signal line LN1 to the p-type first semiconductor layer 23 of the first EA modulator section 103, and modulates the light intensity at the extinction ratio Ex1 (dB). The light modulated by the first EA modulator section 103 passes through the second connected waveguide section 104 and then enters the second EA modulator section 105. The second modulation signal S2, that is, the modulated voltage signal, is input from the second modulation signal line LN2 to the n-type second semiconductor layer 21a of the second EA modulator section 105, and modulates the light intensity at the extinction ratio Ex2 (dB), and emits the modulated light 80 from the end surface to the outside.

The positive-phase signal and the negative-phase signal, that are, the first modulation signal S1 and the second modulation signal S2, are input to the first modulation signal line LN1 and the second modulation signal line LN2, respectively. Consequently, the first EA modulator section 103 and the second EA modulator section 105 appear to be differentially driven. However, the optical modulator integrated semiconductor laser 500 according to Embodiment 1 is characterized in that the first EA modulator section 103 and the second EA modulator section 105 operate as single-phase EA modulators, respectively.

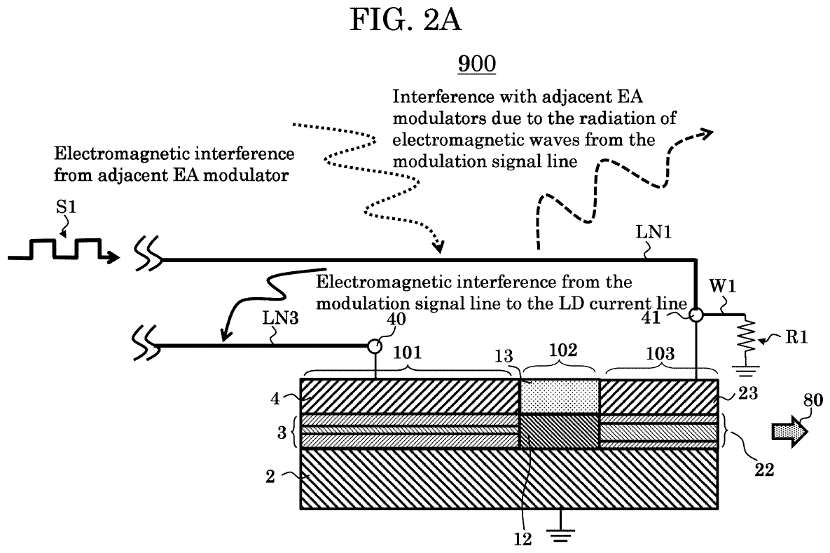

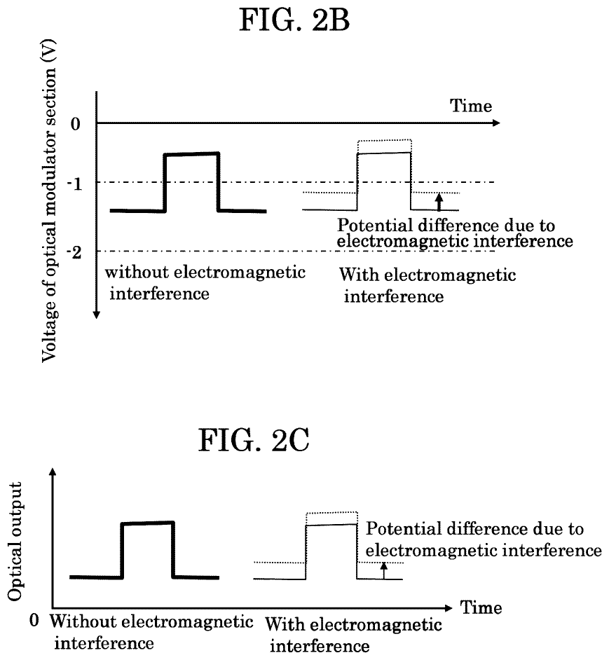

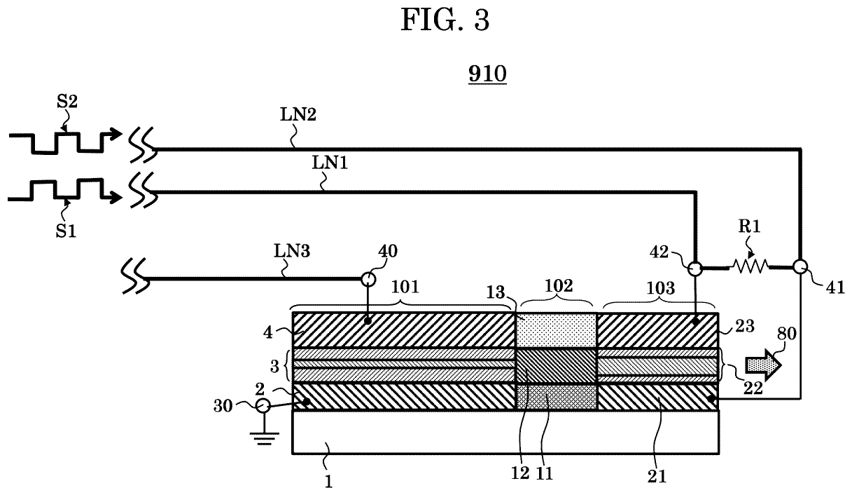

For example, FIG. 2A is a comparative example showing an optical modulator integrated semiconductor laser 900 driven in single-phase with a modulation voltage amplitude of 1 Vpp. FIG. 3 is a comparative example in which a single EA modulator is differentially driven as described in Patent Document 5, and the optical modulator integrated semiconductor laser 910 is driven with a modulation voltage amplitude of 2 Vpp. The increase in the extinction ratio saturates with the increase in the driving voltage, thereby, even if the single EA modulator is differentially driven and modulated with a modulation voltage amplitude of 2 Vpp as in the comparative example, the extinction ratio is not doubled compared to when the single EA modulator is driven in single-phase with a modulation voltage amplitude of 1 Vpp.

In the case of the optical modulator integrated semiconductor laser 500 according to Embodiment 1, the first EA modulator section 103 and the second EA modulator section 105 are independently driven with a modulation voltage amplitude of 1 Vpp.

Since the voltage signals modulating the p-type first semiconductor layer 23 of the first EA modulator section 103 and the n-type second semiconductor layer 21a of the second EA modulator section 105 are in opposite phases to each other, the total extinction ratio Ex12 is expressed by the following Expression (1).

Ex12=Ex1+Ex2 (dB) (1)

In the case where the extinction ratios of each modulator are equal, that are, Ex1=Ex2, the total extinction ratio Ex12 is expressed by the following Expression (2).

Ex12=2×Ex1=2×Ex2 (dB) (2)

Accordingly, the optical modulator integrated semiconductor laser 500 according to Embodiment 1 has a higher extinction ratio than the configuration in which the single EA modulator is differentially driven as shown in the comparative example in FIG. 3. In summary, the extinction ratio is expressed by the following Expressions (3) to (5).

Single-phase drive extinction ratio=Ex1 (3)

Ex1<differential drive extinction ratio <2×Ex1 (4)

Extinction ratio of the optical modulator integrated semiconductor laser according to Embodiment 1=2×Ex1 (5)

Next, it will be explained that the optical modulator integrated semiconductor laser 500 according to Embodiment 1 is also superior in frequency response to the case where the single EA modulator is differentially driven optical modulator integrated semiconductor laser 910 shown in FIG. 3 as a comparative example.

When the output impedance of the driver and the terminating resistor of the EA modulator are denoted by R, respectively, the time constant of the EA modulator driven in single-phase is CR/2. Here, C represents the capacitance of one EA modulator. In the case of differential driving, the impedance is twice as high, so that the time constant is CR. In the optical modulator integrated semiconductor laser 500 according to Embodiment 1, the voltage signals input to each EA modulator are in opposite phases to each other, but the time constant is CR/2 because each EA modulator is driven in single-phase. Therefore, the −3 dB band fc of each EA modulator is expressed by the following Expressions (6) to (8).

Single-phase drive: fc=1/(πCR) (6)

Differential drive: fc=1/(2πCR) (7)

Embodiment 1: fc=1/(πCR) (8)

That is, the optical modulator integrated semiconductor laser 500 according to Embodiment 1 provides the same −3 dB band as the single-phase drive.

When the voltage drop Vd due to the photocurrent Iph generated by light absorption in the EA modulator occurs, a problem occurs that the voltage applied to the p-n junction decreases. In the optical modulator integrated semiconductor laser 500 according to Embodiment 1, as described above, the impedance sensed by the EA modulator is half of that of the differential drive, so that the voltage drop Vd caused by the photocurrent Iph generated by the light absorption in the EA modulator becomes smaller. Furthermore, in the optical modulator integrated semiconductor laser 500 according to Embodiment 1, the voltage drop Vd becomes smaller because the voltage drop is shared by two EA modulators.

For example, in the case where the extinction amount is the same in three types of driving methods of single-phase drive, differential drive, and driving of the optical modulator integrated semiconductor laser 500 according to Embodiment 1 in which the photocurrent is shared equally by two EA modulators, the voltage drop Vd of each method is expressed by the following Expressions (9) to (11).

Single-phase drive: Vd=Iph×R (9)

Differential drive: Vd=Iph×2R (10)

Embodiment 1: Vd=Iph×R/2 (11)

Accordingly, in the optical modulator integrated semiconductor laser 500 according to Embodiment 1, the influence of the photocurrent Iph generated by light absorption is reduced to ½ of the single-phase drive and ¼ of the differential drive.

Furthermore, a feature of the optical modulator integrated semiconductor laser 500 according to Embodiment 1 is that, although each EA modulator operates in a single-phase mode, the device is highly tolerant of external electromagnetic interference from the outside. In a general differential drive, when an electromagnetic field of the same phase, called common noise, is applied from the outside to two parallel wires (electric circuits), the potential of each wire shifts by the same amount of voltage, so that the potential difference between the two wires does not change, and thus is not affected by the electromagnetic field. Meanwhile, the optical modulator integrated semiconductor laser 500 according to Embodiment 1 has improved electromagnetic tolerance because two EA modulators cancel out external electromagnetic interference at the optical level.

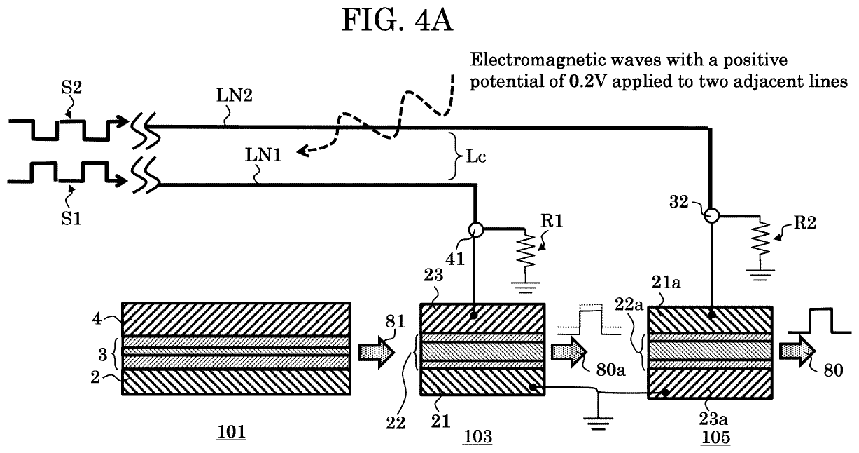

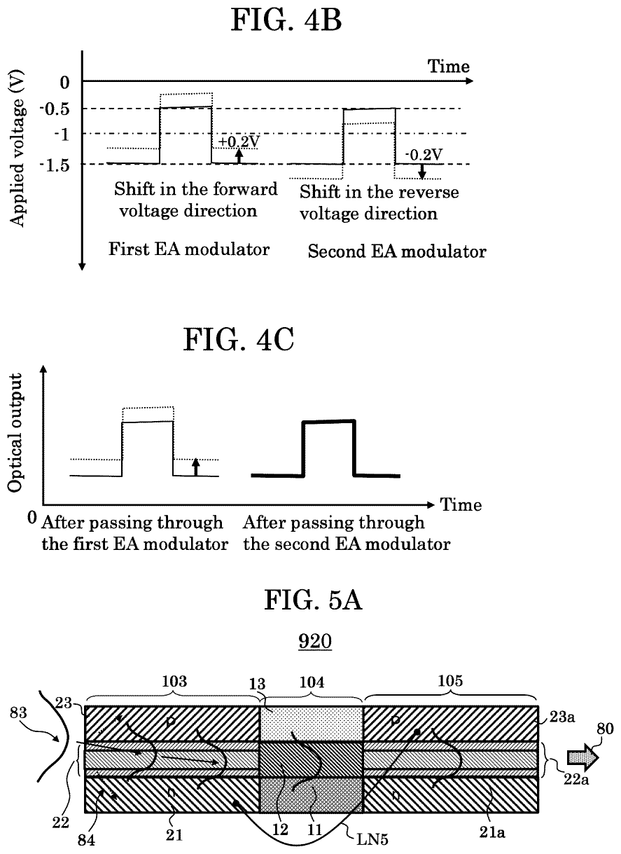

FIG. 4A is a schematic diagram showing the operation of the optical modulator integrated semiconductor laser 500 according to Embodiment 1. In FIG. 4A, the power line of the semiconductor laser section 101, the first connecting waveguide section 102, and the second connecting waveguide section 104 are omitted except for the configuration necessary to explain the reason for the enhanced electromagnetic tolerance. In FIG. 4A, the p-type second semiconductor layer 23a of the second EA modulator section 105 and the n-type second semiconductor layer 21a thereof are shown upside down so that the aspect of the applied voltage can be easily understood.

The EA modulator absorbs and extinguishes light by applying a reverse voltage to the p-n junction. As shown in FIG. 4A, a DC voltage of −1 Vdc, that is, 1 V as a voltage in the reverse direction of the p-n junction, is applied to the p-type first semiconductor layer 23 of the first EA modulator section 103, and the positive-phase signal modulated at high-frequency is applied. When the modulation voltage amplitude Vpp of the positive-phase signal is 1 V, the voltage applied to the p-n junction of the first EA modulator section 103 is from −0.5 V to −1.5 V.

In the second EA modulator section 105, a DC voltage of +1 Vdc, that is, 1 V as a voltage in the reverse direction of the p-n junction, is applied to the n-type second semiconductor layer 21a, and the negative-phase signal modulated at high-frequency is applied. In the case where the modulation voltage amplitude Vpp of the negative-phase signal is 1 V, the voltage applied to the p-n junction of the second EA modulator section 105 is from −0.5 V to −1.5 V, as in the first EA modulator section 103.

Next, a case where electromagnetic interference occurs will be described. The first modulation signal line LN1 and the second modulation signal line LN2 are close to each other, receiving electromagnetic interference of the same magnitude from the outside. For example, assume that electromagnetic interference of +0.2 V is applied to the first modulation signal line LN1 and the second modulation signal line LN2. In this case, as shown in FIG. 4B, in the first EA modulator section 103, a voltage of +0.2 V is applied to the p-type first semiconductor layer 23, and thus the voltage applied to the p-n junction shifts +0.2 V in the forward direction of the p-n junction from −0.3 V to −1.2 V. Therefore, the amount of light transmitted through the first EA modulator section 103 increases.

Meanwhile, in the second EA modulator section 105, a voltage of +0.2 V is applied to the n-type second semiconductor layer 21a, and the voltage applied to the p-n junction shifts 0.2 V in the reverse direction of the p-n junction from −0.7 V to −1.7 V. Therefore, the amount of light transmitted through the second EA modulator section 105 decreases. As a result, the increase or decrease in the amount of light transmitted through the first EA modulator section 103 and the amount of light transmitted through the second EA modulator section 105 cancel each other. That is, as shown in the schematic diagram of the light modulation waveform after passing through the EA modulator in FIG. 4C, the influence of the electromagnetic interference of +0.2 V is canceled by passing through the two EA modulators.

The differences between the optical modulator described in Patent Document 1 and the optical modulator integrated semiconductor laser 500 according to Embodiment 1 will be described below. In the optical modulator described in Patent Document 1, it is explained that two EA modulators are connected and each EA modulator is modulated by positive-phase and negative-phase, but the effect of canceling electromagnetic interference is not mentioned. The reason for this is that, as in the present disclosure, the effect of canceling electromagnetic interference is manifested for the first time by integrating the semiconductor laser section 101 comprising the DFB laser and two EA modulators, that are, the first EA modulator section 103 and the second EA modulator m section 105, to which the positive-phase signal and the negative-phase signal are applied, respectively, into a single device structure.

Cancelling out electromagnetic interference with two EA modulators requires that the amount of change in transmitted light for the same voltage change is equal to each other. The optical absorption coefficient of the MQW layer changes due to the high-frequency voltage amplitude caused by the electromagnetic interference that is added to the first modulation signal line LN1 and the second modulation signal line LN2.

The amount of change in the optical absorption coefficient of the MQW layer constituting a part of the first modulation layer 22 of the first EA modulator section 103 is denoted by Δα1(ω), and the amount of change in the optical absorption coefficient of the MQW layer constituting a part of the second modulatison layer 22a of the second EA modulator section 105 is denoted by Δα2(ω). Then, the condition under which the influence of electromagnetic interference is canceled by passing through two EA modulators is expressed by the following Expression (12).

Γ1×Δα1(ω)×L1=Γ2×Δα2(ω)×L2 (12)

In Expression (12), Γ1 and Γ2 represent the optical confinement factor of the MQW layer of the first EA modulator section 103 and the optical confinement factor of the MQW layer of the second EA modulator section 105, respectively. L1 and L2 represent the length of the first EA modulator section 103 along the optical waveguide direction and the length of the second EA modulator section 105 along the optical waveguide direction, respectively.

In Expression (12), in the case where the MQW layers of the same length and configuration are applied to the first EA modulator section 103 and the second EA modulator section 105, the relationship expressed by the following Expression (13) is satisfied.

Δα1(ω)×L1=Δα2(ω)×L2 (13)

That is, if the optical confinement factor of the MQW layer of each EA modulator is equal, it is possible to satisfy the above-mentioned condition of Expression (12) in the case where Expression (13) is satisfied. Therefore, Γ1=Γ2 is a necessary condition for Expression (12) to be satisfied.

However, in the case of the EA modulator not integrated with the semiconductor laser described in Patent Document 1, it is difficult to satisfy the condition Γ1=Γ2. This is because the width of the MQW layer of the EA modulator is narrow, ranging from 0.8 to 1.6 μm, and the thickness of the MQW layer is also thin, ranging from 50 to 300 nm, so that it is extremely difficult to couple the light emitted from the semiconductor laser to the center of the MQW layer of the EA modulator.

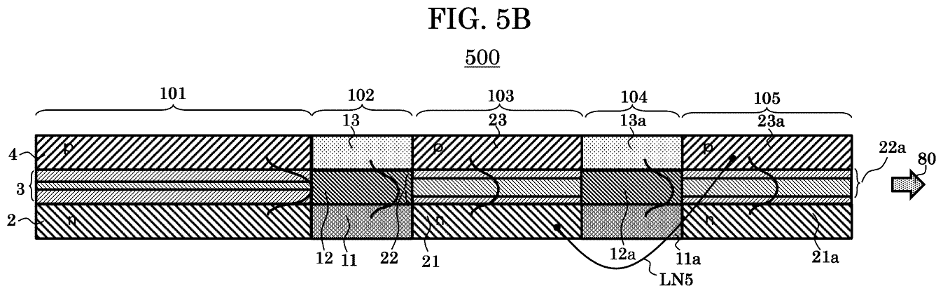

Moreover, even if the light can be coupled to the center of the MQW layer of the EA modulator, a problem occurs that the optical axis deviates from the center of the MQW layer due to the influence of temperature change or vibration. Moreover, the full width at half maximum of the optical mode propagating through the MQW layer of the EA modulator is not the same as that of the optical mode of the incident light passing through the lens system. As a result, the effective optical confinement factor Γ1 of the MQW layer becomes smaller than the optical confinement factor Γ2 of the MQW layer of the second EA modulator section 105 because the radiation mode 84 deviation and the propagation mode deviation occur immediately after the incident light 83 from the external optical system enters the first EA modulator section 103 as in the optical modulator 920 of the comparative example shown in FIG. 5A. Therefore, Γ1≠Γ2 in the comparative example, thus it is not possible to cancel out electromagnetic interference using two EA modulators. Note that, in FIG. 5A, the line LN5 electrically connects the n-type first semiconductor layer 21 and the p-type second semiconductor layer 23a.

In the case of the optical modulator integrated semiconductor laser 500 according to Embodiment 1, the semiconductor laser section 101, which comprises the DFB laser, is integrated, enabling light to be introduced almost in the center of the MQW layer constituting the first modulation layer 22 of the first EA modulator section 103, thus providing an effect of preventing the optical axis from being deviated due to the influence of temperature changes and changes over time.

In general, since the full width at half maximum of the optical mode propagating through the DFB laser is different from that of the optical mode in the EA modulator, there is a concern about radiation due to optical mode mismatch at the time when light enters the first EA modulator section 103. In the optical modulator integrated semiconductor laser 500 according to Embodiment 1, light propagating through the first connecting waveguide section 102 and the second connecting waveguide section 104, which have the same configuration, passes through the first EA modulator section 103 and the second EA modulator section 105, respectively, thereby the optical mode in the first connecting waveguide section 102 and the second connecting waveguide section 104 is transformed into the optical mode inherent to the connecting waveguide while traveling through the connecting waveguide having a length of about 50 μm in the optical waveguide direction.

Consequently, if the first connecting waveguide section 102 and the second connecting waveguide section 104 have the same configuration including the layer thickness, it is possible to control the optical mode incident on the first EA modulator section 103 and the optical mode incident on the second EA modulator section 105 to be the same optical mode. As a result, the optical modulator integrated semiconductor laser 500 according to embodiment 1 satisfies the condition Γ1=Γ2, enabling electromagnetic interference to be canceled.

The first connecting waveguide section 102, which is located between the semiconductor laser section 101 comprising the DFB laser and the first EA modulator section 103, is required to have a certain length in order to have the function of transforming light. The refractive index of InP as the cladding layer is 3.2 for a wavelength of 1.3 μm. Since the length of the first connecting waveguide section 102 required for transforming the optical mode is considered to be about 100 times the wave number, the length calculated from 1.3×100/3.2 is considered to be about 40 μm.

As in the optical modulator integrated semiconductor laser 500 according to Embodiment 1, in the case where two EA modulators are used, the optical loss increases. There is an upper limit to the length of the connecting waveguide section because further reductions in optical output occur when the connecting waveguide section is longer. In the case where the waveguide loss in the connecting waveguide section is 3 cm⁻¹, the length of the connecting waveguide section where the light attenuates by 10% is 350 μm. Consequently, in the case where the length of the first connecting waveguide section 102 between the semiconductor laser section 101 and the first EA modulator section 103 along the optical waveguide direction is 40 μm or more and 350 μm or less, the condition of Γ1=Γ2 is satisfied, thus providing an effect that the electromagnetic interference can be cancel out by two EA modulators, and the suppression of the optical output can be prevented.

Moreover, the optical modulator integrated semiconductor laser 500 according to Embodiment 1 has an effect of reducing the electromagnetic interference between the semiconductor laser section 101 comprising the DFB laser and each EA modulator in the optical modulator integrated semiconductor laser. This is because, although each EA modulator operates in single-phase, the first modulation signal line LN1 and the second modulation signal line LN2 transmit the positive-phase signal and the negative-phase signal, respectively, in the same manner as the differential drive, so that the electromagnetic waves radiated to the outside cancel each other out.

In the present disclosure, the first modulation signal S1 transmitting the first modulation signal line LN1 and the second modulation signal S2 transmitting the second modulation signal line LN2 may be a combination of the negative-phase signal and the positive-phase signal, respectively. That is, it is sufficient that the voltage amplitude of each modulation signal is inverted with respect to each other between the first modulation signal line LN1 and the second modulation signal line LN2.

In addition, as shown in FIG. 1, which shows a cross-sectional view of the optical modulator integrated semiconductor laser 500 according to Embodiment 1, the n-type cladding layer 2 of the semiconductor laser section. 101, the n-type first semiconductor layer 21 of the first EA modulator section 103, and the p-type second semiconductor layer 23a of the second EA modulator section 105 are electrically connected to each other and grounded, so that the potential reference planes of the semiconductor laser section 101, the first EA modulator section 103, and the second EA modulator section 105 are the same. Therefore, the radiation of electromagnetic waves is suppressed and the susceptibility to electromagnetic waves from the outside is suppressed. On the other hand, in the case of differential driving of the EA modulator as a comparative example, since there is no potential reference plane and voltage amplitudes are applied to both the p-type semiconductor layer and the n-type semiconductor layer, there is a problem that a potential difference from the ground plane is likely to occur.

In the semiconductor laser with an electro-absorption type optical modulator described in Patent Document 3, a configuration in which a DFB laser and two modulators are integrated is disclosed. In the device structure described in Patent Document 3, however, the n-type semiconductor layer is not isolated between the first electro-absorption type optical modulator section, the second electro-absorption type optical modulator section, and the DFB laser section. Consequently, even if the n-type first semiconductor layer 21 of the first EA modulator section 103 and the p-type second semiconductor layer 23a of the second EA modulator section 105 are electrically connected by the first common electrode 45 as in the optical modulator integrated semiconductor laser 500 according to Embodiment 1 shown in FIG. 1, the p-n junction of the second electro-absorption type optical modulator is short-circuited and does not operate in the device structure described in Patent Document 3. FIG. 4A shows a configuration in which a negative bias voltage is applied to the p-type first semiconductor layer 23 of the first EA modulator section 103 and a positive bias is applied to the n-type second semiconductor layer 21a of the second EA modulator section 105. By contrast, in the device structure described in Patent Document 3, it is not possible to apply a negative bias voltage to the p-type semiconductor layer of either the first or second field-effect optical modulator, and a positive bias to the n-type semiconductor layer of the other.

### Effects of Embodiment 1

As described above, in the optical modulator integrated semiconductor laser according to Embodiment 1, two EA modulators are provided in a single device, and the semiconductor laser section comprising the DFB laser, the first EA modulator section, and the second EA modulator section are respectively connected by the connecting waveguide section that forms the same optical mode, the n-type semiconductor layer of the first EA modulator section is grounded, and the p-type semiconductor layer thereof is applied with the positive-phase signal, and the p-type semiconductor layer of the second EA modulator section is grounded, and the n-type semiconductor layer thereof is applied with the negative-phase signal, thereby, even if the light intensity passing through the first EA modulator section is fluctuated by electromagnetic interference, the light emitted from the optical modulator integrated semiconductor laser is not affected by electromagnetic interference because the second EA modulator section cancels the fluctuation of the light intensity, thus providing an effect of achieving an optical modulator integrated semiconductor laser that enables the broadening of the bandwidth of optical transceivers, high-density mounting, and the simplification of error correction circuits.

Furthermore, the optical modulator integrated semiconductor laser according to Embodiment 1 can achieve a higher extinction ratio than that of a single-phase drive optical integrated modulator semiconductor laser and a differential drive optical modulator integrated semiconductor laser, so that modulated light can be transmitted over a longer distance, and a wider bandwidth can be obtained than that of a differential drive optical modulator integrated semiconductor laser that is input with the positive-phase signal and the negative-phase signal, thereby large-capacity communication can be achieved.

Furthermore, the optical modulator integrated semiconductor laser according to Embodiment 1 has a smaller voltage drop due to the photocurrent at high light output than that of a single-phase drive optical modulator integrated semiconductor laser and a differential drive optical modulator integrated semiconductor laser. Thus, it is easy to increase the output and advantageous for long-distance transmission. Furthermore, since the optical modulator integrated semiconductor g to Embodiment 1 can achieve a higher extinction ratio, the transmission rate of the optical communication transceiver can be improved when compared with the same optical output, thus providing an effect of reducing the power consumption per bit of the transmission signal.

### Modification of Embodiment 1

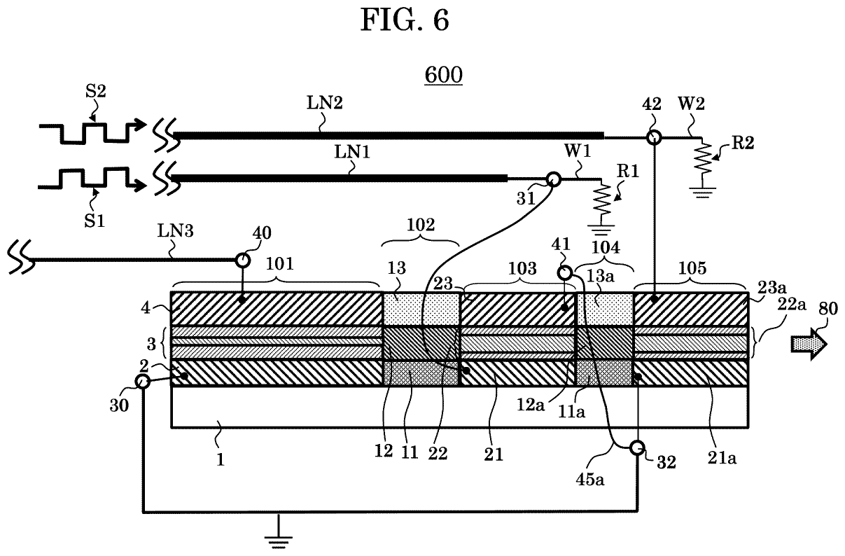

FIG. 6 is a cross-sectional view of an optical modulator integrated semiconductor laser 600 according to Modification of Embodiment 1. The optical modulator integrated semiconductor laser 600 has the same configuration as that of the optical modulator integrated semiconductor laser 500 according to Embodiment 1 in that it includes the semiconductor laser section 101 comprising a DFB laser, the first connecting waveguide section 102, the first EA modulator section 103, the second connecting waveguide section 104, and the second EA modulator section 105.

The p-type electrode 41 of the first EA modulator of the first EA modulator section 103 and the n-type electrode 32 of the second EA modulator of the second EA modulator section 105 are electrically connected by an electrode or wire wiring. In Modification of Embodiment 1, an electrode or wire wiring that electrically connects the p-type electrode 41 of the first EA modulator and the n-type electrode 32 of the second EA modulator is called a second common electrode 45a. In the example shown in FIG. 6, the second common electrode 45a is electrically connected to the ground and the n-type electrode 30 of the semiconductor laser section 101. However, the second common electrode 45a is not necessarily connected to either or both of the ground and the n-type electrode 30 of the semiconductor laser section.

The first modulation signal line LN1 that transmits the first modulation signal S1 for modulating the first t EA modulator section 103 is electrically connected to the n-type electrode 31 of the first EA modulator of the first EA modulator section 103. The second modulation signal line LN2 for transmitting the second modulation signal S2 for modulating the second EA modulator section 105 is electrically connected to the p-type electrode 42 of the second EA modulator of the second EA modulator section 105. The first modulation signal line LN1 and the second modulation signal line LN2 are arranged close to each other in parallel, and electromagnetic fields are mutually coupled.

The first modulation signal line LN1 and the second modulation signal line LN2 are electrically connected to drivers (not shown) that output a modulation signal, respectively. The first modulation signal S1 and the second modulation signal S2 for transmitting the first modulation signal line LN1 and the second modulation signal line LN2 are modulated as signals of opposite phases, such as a positive-phase signal and a negative-phase signal, respectively. DC current is supplied to the semiconductor laser section 101 through the semiconductor laser section current line LN3.

### <Operation and Effects of Modification of Embodiment 1>

As described above, the optical modulator integrated semiconductor laser according to Modification of Embodiment 1 has basically the same operation and effect as the optical modulator integrated semiconductor laser according to Embodiment 1. However, considering that the first upper cladding layer 13 and the first lower cladding layer 11 of the first connecting waveguide section 102 act as resistors for isolating the first EA modulator section 103 and the semiconductor laser section 101, in order to reduce a leak current to the semiconductor laser section 101 side by the modulation signal and DC bias voltage applied to the first EA modulator section 103, it is preferable to choose between the device structure of Embodiment 1 and the device structure of Modification of Embodiment 1 differently.

In Embodiment 1, since the modulation signal and DC bias voltage are applied to the p-type electrode 41 of the first EA modulator of the first EA modulator section 103, it is preferable that the resistance of the first upper cladding layer 13 of f the first connecting waveguide section 102 is higher than the resistance of the first lower cladding layer 11 thereof. By contrast, in Modification of Embodiment 1, since the modulation signal and the DC bias voltage are applied to the n-type electrode 31 of the first EA modulator of the first EA modulator section 103, it is preferable that the resistance of the first lower cladding layer 11 of the first connecting waveguide section 102 is higher than the resistance of the first upper cladding layer 13 thereof.

Specifically, in Embodiment 1, in the case where a DC bias voltage of −1 V is applied to the p-type electrode 41 of the first EA modulator of the first EA modulator section 103 and +1.5 V is applied to the p-type electrode 40 of the semiconductor laser section 101, a bias voltage difference of 2.5 V is applied between both electrodes. In the case where the resistance of the first upper cladding layer 13 of the first connecting waveguide section 102 provided between the semiconductor laser section 101 and the first EA modulator section 103 is 1500Ω, a current of 1.7 mA flows from the semiconductor laser section 101 to the first EA modulator section 103 as a leak current, thereby the drive current of the DFB laser constituting the semiconductor laser section 101 fluctuates, and thus the optical output fluctuates.

On the other hand, in Modification of Embodiment 1, since the p-type electrode 41 of the first EA modulator of the first EA modulator section 103 is grounded, the potential of the p-type electrode 41 of the first EA modulator is 0 V. When +1.5 V is applied to the p-type electrode 40 of the semiconductor laser section 101, a bias voltage difference of 1.5 V is applied between both electrodes. In the case where the resistance of the first upper cladding layer 13 of the first connecting waveguide section 102 is 1500Ω, the leak current is suppressed to 1.0 mA, and thus the influence of the leak current is suppressed. Since the leak current from the semiconductor laser section 101 is preferably 1 mA or less, in the case where the resistance of the first upper cladding layer 13 of the first connecting waveguide section 102 is 1500Ω or less, the device structure of Modification of Embodiment 1 is more preferable than the device structure of Embodiment 1.

### Embodiment 2

### <Device Structure of Optical Modulator Integrated Semiconductor Laser According to Embodiment 2>

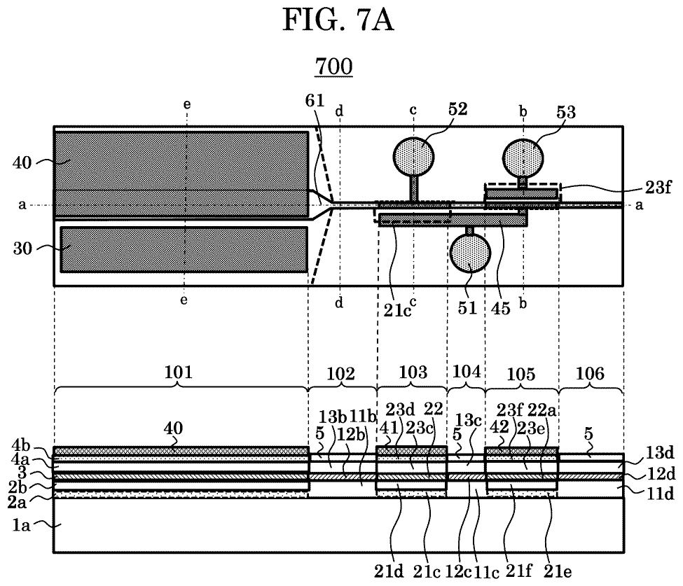

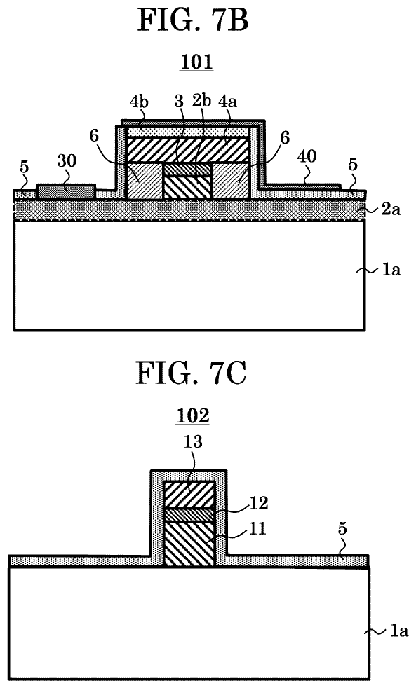

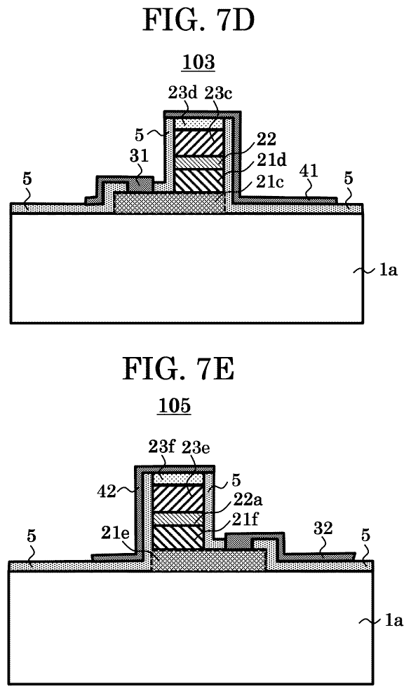

In Embodiment 2, a more specific configuration to realize the optical modulator integrated semiconductor laser according to Embodiment 1 will be described. FIG. 7A is a cross-sectional view in the direction parallel to the optical waveguide direction and a top view showing the device structure of the optical modulator integrated semiconductor laser 700 according to Embodiment 2. FIGS. 7B to 7E show cross-sectional views, in the direction perpendicular to the optical waveguide direction, of a semiconductor laser section 101, a first connecting waveguide section 102, a first EA modulator section 103, and a second EA modulator section 105 of the optical modulator integrated semiconductor laser 700 according to Embodiment 2.

As shown in the cross-sectional view of FIG. 7A, the optical modulator integrated semiconductor laser 700 according to Embodiment 2 comprises the semiconductor laser section 101 comprising a DFB laser, the first connecting waveguide section 102, the first EA modulator section 103, a second connected waveguide section 104, the second EA modulator section 105, and a waveguide lens section 106, which are connected sequentially along the optical waveguide direction on an Fe-doped InP substrate 1a.

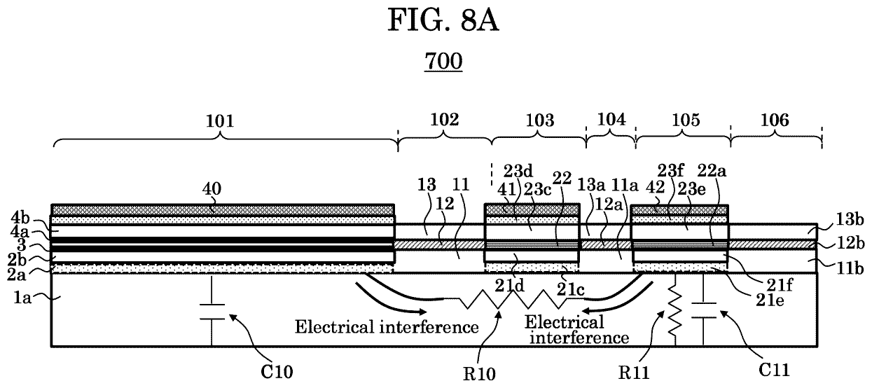

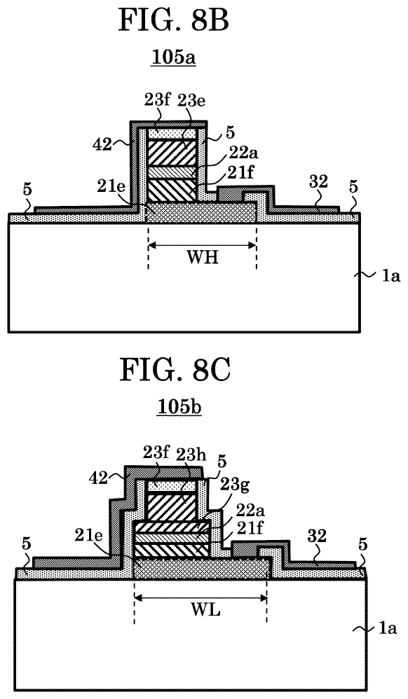

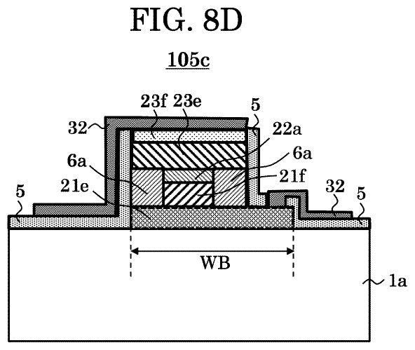

In the description of Embodiment 2, the waveguide configuration is explained. FIG. 8B is a cross-sectional view of a second EA modulator 105a representing one example of the second EA modulator 105, and FIG. 8C is a cross-sectional view of a second EA modulator 105b representing another example of the second EA modulator 105.

As shown in FIG. 8B, a waveguide structure is called a high-mesa waveguide where the width of the mesa, in which light is horizontally confined and guided, is almost the same as the width of the second modulation layer 22a, where the semiconductor layers on both side surfaces of the second modulation layer 22a have been removed.

By contrast, as shown in the cross-sectional view of a second EA modulator 105b in FIG. 8C, a waveguide structure is called a low-mesa waveguide where the width of the mesa (in this case, the width of the p-type semiconductor layer 23h), in which light is horizontally confined and guided, is narrower than the width of the second modulation layer 22a. The low-mesa waveguide is sometimes called a rib waveguide. As shown in the cross-sectional view of the second EA modulator 105c in FIG. 8D, a structure in which both side surfaces of the second modulation layer 22a are buried by buried semiconductor layers 6a is called a buried waveguide.

With reference to FIGS. 7B to 7E, the respective structures of the semiconductor laser section 101, the first connecting waveguide section 102, the first EA modulator section 103, the second connecting waveguide section 104, the second EA modulator section 105, and the waveguide lens section 106 constituting the optical modulator integrated semiconductor laser 700 according to Embodiment 2 will be described below.

The semiconductor laser section 101 comprising the DFB laser shown in the cross-sectional view of FIG. 7B includes: an n-type InGaAsP conductive layer 2a having a carrier concentration of 0.5×10¹⁸ to 8×10¹⁸ cm⁻³ and a thickness of 0.1 to 1.0 μm; an n-type InP cladding layer 2b having a carrier concentration of 0.5×10¹⁸ to 8×10¹⁸ cm⁻³ and a thickness of 0.1 to 3.0 μm; an active layer 3; a p-type InP cladding layer 4a having a carrier concentration of 0.5×10¹⁸ to 8×10¹⁸ cm⁻³ and a thickness of 0.1 to 3.0 μm; a p-type InGaAs contact layer 4b having a carrier concentration of 0.5×10¹⁸ to 8×10¹⁸ cm⁻³ and a thickness of 0.1 to 1.0 μm; which are sequentially formed above an Fe-doped InP substrate 1a, and a p-type electrode 40 of the semiconductor laser section using a metal material such as Ti, Pt, and Au.

The active layer 3 is a multilayer structure with a total thickness of 80 to 400 nm. The active layer 3 comprises a diffraction grating layer made of InGaAsP or InAlGaAs, an InP barrier layer, optical confinement layers made of InGaAsP or InAlGaAs, and a multiple quantum well layer (MQW layer) made of InGaAsP or InAlGaAs.

The width of the active layer 3 is 1 to 2 μm. As shown in the cross-sectional view of FIG. 7B, the active layer 3 has a buried waveguide structure in which both side surfaces of the active layer 3 are buried by current blocking layers 6 made of InP.

The outside of the buried waveguide is etched until the surface of the n-type InGaAsP conductive layer 2a is reached, and then the n-type electrode 30 of the semiconductor laser section is formed on the n-type InGaAsP conductive layer 2a. Both side surfaces of the buried waveguide are covered with an insulating protection film 5. The length of the semiconductor laser section 101 along the optical waveguide direction is 150 to 1000 μm.

The diffraction grating (not shown) of the DFB laser constituting the semiconductor laser section 101 may have a λ/4 shift structure. An anti-reflection film (not shown) is formed on the rear end surface of the DFB laser. But in the case of an asymmetric structure in which the λ/4 shift t structure is not located at the center, a high-reflection film of 70% or more may be formed on the rear end surface side.

As shown in the cross-sectional view of FIG. 7C, the first connecting waveguide section 102, in which a waveguide is connected to the semiconductor laser section 101 comprising the DFB laser, includes: a first lower cladding layer 11 made of i-type, n-type or p-type InP and having a carrier concentration of 2×10¹⁸ cm⁻³ or less and a thickness of 0.1 to 3.0 μm; a first waveguide layer 12 made of i-type, n-type or p-type InGaAsP and having a carrier concentration of 1×10¹⁸ cm⁻³ or less and a thickness of 80 to 400 nm; and a first upper cladding layer 13 made of i-type, n-type or p-type InP and having a carrier concentration of 2×10¹⁸ cm⁻³ or less and a thickness of 0.1 to 3.0 μm, which are sequentially formed above the Fe-doped InP substrate 1a. The first waveguide layer 12 made of InGaAsP may be composed of an InAlGaAs waveguide layer.

The first connecting waveguide section 102 has a length of 40 to 350 μm along the optical waveguide direction. The waveguide width of the first connecting waveguide section 102 is tapered from the buried waveguide on the semiconductor laser section 101 side to the high-mesa waveguide on the first EA modulator section 103 side, and thus the waveguide is converted from the buried waveguide to the high-mesa waveguide. FIG. 7C is a cross-sectional view of the first connecting waveguide section 102 after conversion to the high-mesa waveguide. The width of the high-mesa waveguide is 0.5 to 2 μm.

As shown in the cross-sectional view of FIG. 7D, the first EA modulator section 103, in which a waveguide is connected to the first connecting waveguide section 102, includes: an n-type InGaAsP first conductive layer 21c having a carrier concentration of 0.5×10¹⁸ to 8×10¹⁸ cm⁻³ and a thickness of 0.1 to 1.0 μm; an n-type InP first cladding layer 21d having a carrier concentration of 0.5×10¹⁸ to 8×10¹⁸ cm⁻³ and a thickness of 0.1 to 3.0 μm; a first modulation layer 22; a p-type InP first cladding layer 23c having a carrier concentration of 0.5×10¹⁸ to 8×10¹⁸ cm⁻³ and a thickness of 0.1 to 3.0 μm; a p-type InGaAs first contact layer 23d having a carrier concentration of 0.5×10¹⁸ to 8×10¹⁸ cm⁻³ and a thickness of 0.1 to 1.0 μm; which are sequentially formed above the Fe-doped InP substrate 1a, and an p-type electrode 41 of the first EA modulator using a metallic material such as Ti, Pt, and Au.

The first modulation layer 22 comprises a multilayer structure consisting of InGaAsP or InAlGaAs optical confinement layers and an InGaAsP or InAlGaAs multiple quantum well layer with a thickness of 80 to 400 nm. The width of the first modulation layer 22 is 0.5 to 2 μm.

The n-type InGaAsP first conductive layer 21c and the n-type InP first cladding layer 21d are collectively called an n-type first semiconductor layer. The p-type InP first cladding layer 23c and the p-type InGaAs first contact layer 23d are collectively called a p-type first semiconductor layer.

As shown in the cross-sectional view of FIG. 7D, the outside of the high-mesa waveguide is etched up to the Fe-doped InP substrate 1a. But the n-type InGaAsP first conductive layer 21c remains on at least one side, and the n-type electrode 31 of the first EA modulator is formed on the n-type InGaAsP first conductive layer 21c in the remaining area thereof. The width of the n-type InGaAsP first conductive layer 21c remaining on the outside of the high-mesa waveguide is 1 to 30 μm. The length of the first EA modulator section 103 along the optical waveguide direction is 30 to 200 μm.

The second connecting waveguide section 104, in which a waveguide is connected to the first EA modulator section 103, includes: a second lower cladding layer 11a made of i-type, n-type or p-type InP and having a carrier concentration of 2×10¹⁸ cm⁻³ or less and a thickness of 0.1 to 3.0 μm; a second waveguide layer 12a made of i-type, n-type or p-type InGaAsP and having a carrier concentration of 1×10¹⁸ cm⁻³ or less and a thickness of 80 to 400 nm; and a second upper cladding layer 13a made of i-type, n-type or p-type InP and having a carrier concentration of 2×10¹⁸ cm⁻³ or less and a thickness of 0.1 to 3.0 μm, which are sequentially formed above the Fe-doped InP substrate 1a. The second waveguide layer 12a made of InGaAsP may be made of InAlGaAs.

The second connected waveguide section 104 comprises the high-mesa waveguide having a length of 40 to 350 μm along the optical waveguide direction. The width of the high-mesa waveguide is 0.5 to 2 μm. The waveguide structure of the second connecting waveguide section 104 is similar to that of the first connecting waveguide section 102 shown in FIG. 7C.

That is, the second connecting waveguide section 104 comprises the second lower cladding layer 11a made of i-type, n-type, or p-type InP, the second waveguide layer 12a made of i-type, n-type, or p-type InGaAsP, and the second upper cladding layer 13a made of i-type, n-type, or p-type InP, which are sequentially formed above the Fe-doped InP substrate 1a. The second waveguide layer 12a made of InGaAsP may be made of InAlGaAs.

As shown in the cross-sectional view of FIG. 7E, the second EA modulator section 105, in which a waveguide is connected to the second connecting waveguide section 104, includes: an n-type InGaAsP second conductive layer 21e having a carrier concentration of 0.5×10¹⁸ to 8×10¹⁸ cm⁻³ and a thickness of 0.1 to 1.0 μm; an n-type InP second cladding layer 21f having a carrier concentration of 0.5×10¹⁸ to 8×10¹⁸ cm⁻³ and a thickness of 0.1 to 3.0 μm; a second modulation layer 22a; a p-type InP second cladding layer 23e having a carrier concentration of 0.5×10¹⁸ to 8×10¹⁸ cm⁻³ and a thickness of 0.1 to 3.0 μm; a p-type InGaAs second contact layer 23f having a carrier concentration of 0.5×10¹⁸ to 8×10¹⁸ cm⁻³ and a thickness of 0.1 to 1.0 μm; which are sequentially formed above the Fe-doped InP substrate 1a, and an p-type electrode 42 of the second EA modulator using a metallic material such as Ti, Pt, and Au.

The n-type InGaAsP second conductive layer 21e and the n-type InP second cladding layer 21f are collectively referred to as an n-type second semiconductor layer. The p-type InP second cladding layer 23e and the p-type InGaAs second contact layer 23f are collectively referred to as a p-type second semiconductor layer.

The second modulation layer 22a comprises a multilayer structure consisting InGaAsP or InAlGaAs optical confinement layers and an InGaAsP or InAlGaAs multiple quantum well layer with a thickness of 80 to 400 nm. The width of the second modulation layer 22 is 0.5 to 2 μm.

As shown in the cross-sectional view of FIG. 7E, the outside of the high-mesa waveguide is etched up to the Fe-doped InP substrate 1a. But the n-type InGaAsP second conductive layer 21e remains on at least one side, and the n-type electrode 32 of the second EA modulator is formed on the n-type InGaAsP second conductive layer 21e. The width of the n-type InGaAsP second conductive layer 21e remaining on the outside of the high-mesa waveguide is 1 to 30 μm. The length of the second EA modulator 105 along the optical waveguide direction is 30 to 200 μm.

The waveguide lens section 106, in which a waveguide is connected to the second EA modulator section 105, includes: an n-type or a p-type InP third lower cladding layer 11d having a carrier concentration of 2×10¹⁸ cm⁻³ or less and a thickness of 0.1 to 3.0 μm; an n-type or a p-type InGaAsP third waveguide layer 12d having a carrier concentration of 1×10¹⁸ cm⁻³ or less and a thickness of 80 to 400 nm; and an n-type or a p-type InP third upper cladding layer 13d having a carrier concentration of 2×10¹⁸ cm⁻³ or less and a thickness of 0.1 to 3.0 μm, which are sequentially formed above the Fe-doped InP substrate. The InGaAsP third waveguide layer 12d may be composed of an InAlGaAs waveguide layer. The width of the high-mesa waveguide gradually widens toward the front end surface, and thus the waveguide is converted from the high-mesa waveguide to the buried waveguide. The modulated light 80 is emitted from the front end surface. A non-reflection film (not shown) is formed on the front end surface.

The semiconductor layers described above are crystal-grown by MOCVD (Metal Organic Chemical Vapor Deposition) or MBE (Molecular Beam Epitxy). Simultaneous crystal growth of each modulation layer of the first EA modulator section 103 and the second EA modulator section 105 improves the effect of canceling out electromagnetic interference by aligning the optical absorption characteristics. In addition, simultaneous crystal growth of each InGaAsP waveguide layer of the first connecting waveguide section 102 and the second connecting waveguide section 104 also improves the effect of canceling out electromagnetic interference by aligning the modes of light propagation.

Next, the configuration of the upper surface side of the optical modulator integrated semiconductor laser 700 will be described on the basis of the top view of FIG. 7A. The semiconductor laser section 101 includes: the n-type electrode 30 of the semiconductor laser section formed on the n-type InGaAsP conductive layer 2a and electrically connected to the n-type InGaAsP conductive layer 2a; and the p-type electrode 40 of the semiconductor laser section formed on the p-type InGaAs contact layer 4b and electrically connected to the p-type InGaAs contact layer 4b.

In the first connecting waveguide section 102, the waveguide width changes in a tapered manner from the buried waveguide on the semiconductor laser section 101 side to the high-mesa waveguide on the first EA modulator section 103 side. That is, the first connecting waveguide section 102 has a waveguide conversion section 61 for converting from the buried waveguide to the high-mesa waveguide.

The first EA modulator section 103 includes: the n-type electrode 31 of the first EA modulator formed on the n-type InGaAsP first conductive layer 21c and electrically connected to the n-type InGaAsP first conductive layer 21c; and the p-type electrode 41 of the first EA modulator formed on the p-type InGaAs first contact layer 23d and electrically connected to the p-type InGaAs first contact layer 23d. The p-type electrode 41 of the first EA modulator is electrically connected to a wire bonding pad 52 for the p-type electrode of the first EA modulator formed on the surface of the optical modulator integrated semiconductor laser 700 through an electrode pattern or wire wiring.

The second EA modulator section 105 includes: the n-type electrode 32 of the second EA modulator formed on the n-type InGaAsP second conductive layer 21e and electrically connected to the n-type InGaAsP second conductive layer 21e; and the p-type electrode 42 of the second EA modulator formed on the p-type InGaAs second contact layer 23f and electrically connected to the p-type InGaAs second contact layer 23f. The n-type electrode 32 of the second EA modulator is electrically connected to a wire bonding pad 53 for the n-type electrode of the second EA modulator formed on the surface of the optical modulator integrated semiconductor laser 700 through an electrode pattern or wire wiring.

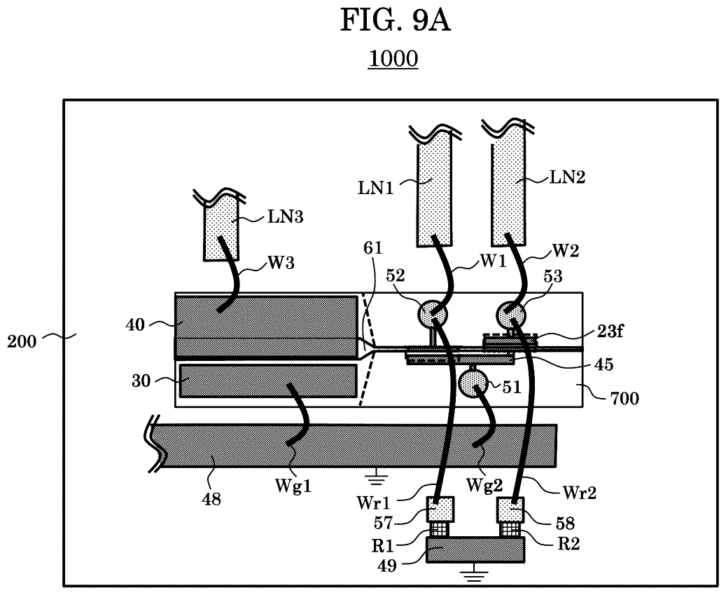

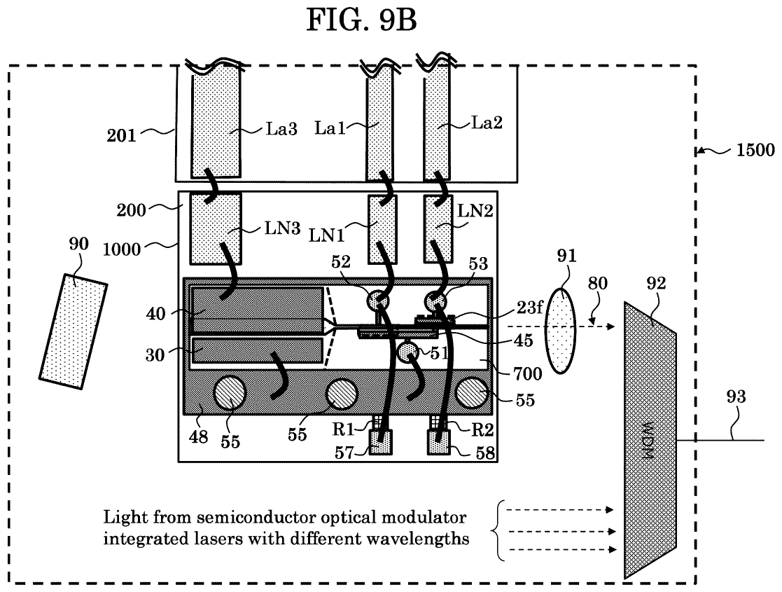

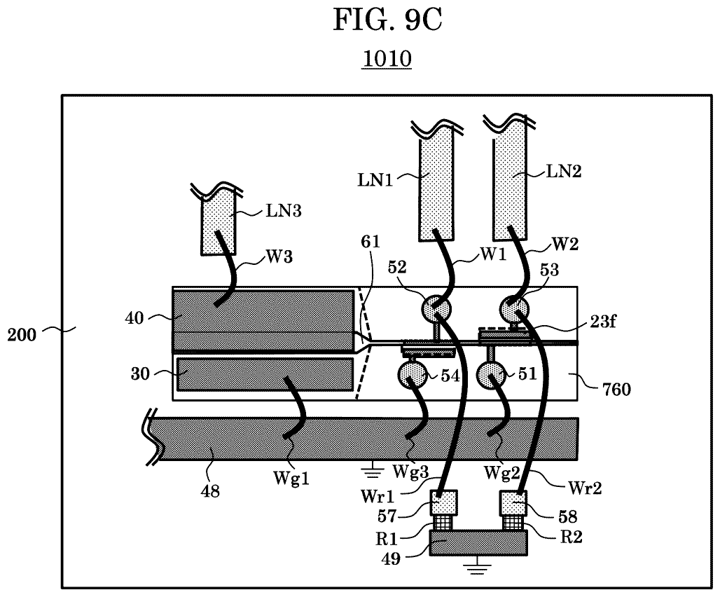

A first common electrode 45 is formed on the surface of the optical modulator integrated semiconductor laser 700. The first common electrode 45 is electrically connected to the n-type electrode 31 of the first EA modulator and the p-type electrode 42 of the second EA modulator through an electrode pattern or wire wiring. The first common electrode 45 is electrically connected to a wire bonding pad 51 for the first common electrode through an electrode pattern or wire wiring. In Embodiment 2, the first common electrode 45 itself is also formed by an electrode pattern or wire wiring. For this reason, in FIG. 7A, the n-type electrode 31 of the first EA modulator and the p-type electrode 42 of the second EA modulator are shown as the first common electrode 45 and are not directly illustrated. The same applies to FIGS. 9A, 9B, 10, 11, 12, 13B.

### <Action of Optical Modulator Integrated Semiconductor Laser According to Embodiment 2>

The optical modulator integrated semiconductor laser 700 according to Embodiment 2 has the same action as the optical modulator integrated semiconductor laser 500 according to Embodiment 1. The optical modulator integrated semiconductor laser 700 according to Embodiment 2 further has the action of reducing electromagnetic interference. The action peculiar to the optical modulator integrated semiconductor laser 700 according to Embodiment 2 will be described below.

In the single-phase driving EA modulator integrated in the optical modulator integrated semiconductor laser as in the comparative example, since the n-type semiconductor layer is grounded, the n-type semiconductor layer does not affect electromagnetic interference. On the other hand, in the optical modulator integrated semiconductor laser according to Embodiment 1, the n-type second semiconductor layer 21a of the second EA modulator section 105 is not grounded because it is necessary to modulate the n-type second semiconductor layer 21a with a negative-phase signal. In this case, since the semiconductor laser section 101, the first EA modulator section 103, and the second EA modulator section 105 are integrated on the semi-insulating substrate 1 having a finite resistivity, which may be affected by electromagnetic interference.

Even in the optical modulator integrated semiconductor laser 700 according to Embodiment 2, as shown in the schematic diagram of FIG. 8A, if the n-type second semiconductor layer of the second EA modulator section 105, that is, the n-type InGaAsP second conductive layer 21e, has a large area in contact with the Fe-doped InP substrate 1a, this may cause a leak current. In particular, if the voltage of the modulation signal leaks to the n-type semiconductor layer, that is, the n-type InGaAsP conductive layer 2a, of the DFB laser constituting the semiconductor laser section 101, the DFB laser receives electromagnetic interference. Here, the Fe-doped InP substrate 1a has a resistivity of 1×10⁷ Ω·cm.

Therefore, in order to reduce electromagnetic interference from the second EA modulator section 105 to the DFB laser, it is necessary to make the area of the n-type second semiconductor layer of the second EA modulator section 105, that is, the n-type InGaAsP second conductive layer 21e, as small as possible. The area of the n-type second semiconductor layer of the second EA modulator section 105 strongly depends on the waveguide structure.

FIG. 8D is a cross-sectional view showing the configuration of a comparative example in which a buried waveguide is applied to the second EA modulator section 105. The width of the second modulation layer 22a which is 1.5 μm, plus the width of the buried semiconductor layers 6a on both side surfaces of the second modulation layer 22a, makes a total of 10 μm. The contact width between the n-type electrode 32 of the second EA modulator and the n-type InGaAsP second conductive layer 21e in the second EA modulator section 105c is 20 μm. Thus, the width WB of the n-type second semiconductor layer, that is, the n-type InGaAsP second conductive layer 21e, is required to be 31.5 μm.

In the case of the high-mesa waveguide shown in the cross-sectional view of FIG. 8B, the width WH of the n-type second semiconductor layer is the total width of the width 1.5 μm of the second modulation layer 22a and the width 20 μm of the n-type electrode contact area. That is, the width WH of the n-type second semiconductor layer is 21.5 μm, which is reduced to about 68% of the width WB.

In the case of the low-mesa waveguide shown in the cross-sectional view of FIG. 8C, the width WL of the n-type second semiconductor layer is the total width of the width 5.5 μm of the second modulation layer 22a and the width 20 μm of the n-type electrode contact area. That is, the width WL of the n-type second semiconductor layer is 25.5 μm, which is reduced to about 81% of the width WB.

Consequently, the relationship between the large and small values of the width WB, the width WH, and the width WL is expressed by the following Expression (14).

WH<WL<WB (14)

The influence of electromagnetic interference and DC bias voltage through the Fe-doped InP substrate 1a can be reduced by applying the high-mesa waveguide or the low-mesa waveguide to at least the second EA modulator section 105, instead of the same buried waveguide as the semiconductor laser section 101 comprising the DFB laser.

The n-type second semiconductor layer of the second EA modulator section 105 also functions as a parasitic capacitance. The dielectric constant of the Fe-doped InP substrate 1a is denoted by ε, the thickness thereof is denoted by T, the length of the second EA modulator section 105 along the optical waveguide direction is denoted by L2, and the width of the n-type second semiconductor layer is denoted by W. The parasitic capacitance of the n-type second semiconductor layer through the Fe-doped InP substrate 1a is expressed by the following Expression (15).

C=ε×L2×W/T (15)

The capacitances of each n-type second semiconductor layer of the high-mesa waveguide, the low-mesa waveguide, and the buried waveguide is denoted by CH, CL, and CB, respectively. The relationship between the large and small values of the capacitances is expressed by the following Expression (16).

CH<CL<CB (16)

Consequently, the application of the high-mesa waveguide allows the parasitic capacitance of the n-type second semiconductor layer of the second EA modulator 105 to be reduced, thereby favorably affecting the broadband characteristics of the integrated optical modulator semiconductor laser.

Since the n-type first semiconductor layer is grounded in the first EA modulator section 103, the parasitic capacitance of the n-type first semiconductor layer is not added. For this reason, the first EA modulator section 103 has better response at high frequencies than the second EA modulator section 105, which has the parasitic capacitance of the n-type second semiconductor layer added thereto. From Expression (13), in the case where the first EA modulator section 103 and the second EA modulator section 105 have the same length, the condition for canceling the electromagnetic interference is expressed by the following Expression (17).

Δα1(ω)=Δα2(ω) (17)

Δα1(ω) and Δα2(ω) represent changes in the optical absorption coefficient during modulation, that is, responses to high frequencies. In order for Expression (17) to be satisfied, the frequency response characteristics of the first EA modulator 103 and the second EA modulator 105 are required to be identical. In order to match the frequency responses of the first EA modulator 103 and the second EA modulator 105 in the band of 100 GHz or higher, the difference in parasitic capacitance is required to be kept to 5 fF or less.

Assuming that the dielectric constant of the Fe-doped InP substrate 1a is 12, the thickness of the substrate is 100 μm, and the length of the second EA modulator 105 along the optical waveguide direction is 100 μm, and the width WH of the n-type second semiconductor layer that can be realized by the high-mesa waveguide is 21.5 μm, the parasitic capacitance C of the n-type second semiconductor layer through the Fe-doped InP substrate 1a is 2.3 fF, which is sufficiently small. That is, the parasitic capacitance of the n-type second semiconductor layer of the second EA modulator 105 is reduced, and thus the high-frequency response characteristics of the second EA modulator 105 are the same as those of the first EA modulator 103, and Expression (17) is satisfied, so that the effect of canceling electromagnetic interference is improved.

In order to satisfy the parasitic capacitance C of about 5 fF, the width of the n-type second semiconductor layer is required to be 48 μm or less. In the case of the high-mesa waveguide, it is possible to fabricate the n-type second semiconductor layer with a width of 48 μm or less with sufficient margin of processing accuracy. Furthermore, in recent years, there has been a growing demand to reduce the drive voltage of the EA modulator in order to save power. If the length of the EA modulator is increased to 150 μm in order to reduce the drive voltage, then from Expression (15), the values of CH for the high-mesa waveguide and CL for the low-mesa waveguide are 3.45 fF and 4.09 fF, respectively. By contrast, the value of CB for the buried waveguide is 5.05 fF, which makes it difficult to cancel electromagnetic interference in the buried waveguide.

### Effects of Embodiment 2

As described above, the optical modulator integrated semiconductor laser according to Embodiment 2 has the same effect as the optical modulator integrated semiconductor laser according to Embodiment 1. The optical modulator integrated semiconductor laser according to Embodiment 2 also has the effect of reducing electromagnetic interference. The optical modulator integrated semiconductor laser according to Embodiment 2 has two EA modulators in a single device, and the semiconductor laser section 101 comprising the DFB laser having the buried waveguide, the first EA modulator section 103 having the high-mesa waveguide, and the second EA modulator section 105 having the high-mesa waveguide are connected by the first connecting waveguide section 102 having the high-mesa waveguide and the second connecting waveguide section 104 having the high-mesa waveguide with the same optical mode, respectively. The n-type first semiconductor layer of the first EA modulator section 103 is grounded to apply the positive-phase signal to the p-type first semiconductor layer, and the p-type second semiconductor layer of the second EA modulator section 105 is grounded to apply the negative-phase signal to the n-type second semiconductor layer.

Even if the light intensity of passing through the first EA modulator section 103 is fluctuated by electromagnetic interference, the second EA modulator section 105 cancels the fluctuation of the light quantity, thereby the light emitted from the optical modulator integrated semiconductor laser is not affected by electromagnetic interference. Furthermore, since the n-type second semiconductor layer of the second EA modulator section 105 is narrowed by the high-mesa waveguide, electromagnetic interference and parasitic capacitance through the Fe-doped InP substrate 1a are reduced.

Moreover, according to the optical modulator integrated semiconductor laser according to Embodiment 2, electromagnetic interference between the second EA modulator section 105 through the Fe-doped InP substrate 1a and the semiconductor laser section 101 comprising the DFB laser can be reduced. Furthermore, the high-frequency responses of the first EA modulator section 103 and the second EA modulator section 105 almost match, thereby electromagnetic interference can be canceled, thus providing an effect of achieving an optical modulator integrated semiconductor laser that enables the broadening of the bandwidth of optical transceivers, high-density mounting, and simplification of the error rate correction circuits.

### Embodiment 3

### <Configuration of Optical Modulator Integrated Semiconductor Laser and Optical Module According to Embodiment 3>

FIG. 9A is a top view of the optical module 1000 according to Embodiment 3. The optical module 1000 according to Embodiment 3 includes, as a configuration of the optical module 1000, the arrangement of each electrode of the optical modulator integrated semiconductor laser according to Embodiment 3 and the connection of signal lines and ground lines with wires.

Specifically, in the optical module 1000 according to Embodiment 3, the optical modulator integrated semiconductor laser 700 according to Embodiment 2 is arranged on a mounting substrate 200, and each wire bonding pad on the optical modulator integrated semiconductor laser 700 and each terminating resistor and the like arranged on the mounting substrate 200 are electrically connected through wires made of metal. In Embodiment 3, the mounting substrate 200 on which the optical modulator integrated semiconductor laser 700 is mounted is a substrate made of aluminum nitride, which is also called a sub-mount. But this is not limited thereto, and the mounting substrate 200 may be made of other materials, or the mounting substrate 200 may be a configuration in which the optical modulator integrated semiconductor laser 700 once mounted on the sub-mount is secondarily mounted on another mounting substrate.

Components such as a first modulation signal line LN1, a second modulation signal line LN2, a semiconductor laser section current line LN3, a grounding electrode 48, a first terminating resistor R1, and a second terminating resistor R2 are arranged on the mounting substrate 200. The grounding electrode 48 is not necessarily required to be 0 V with respect to the ground, but may be short-circuited with the ground plane at high-frequency through a large capacitor. In the present disclosure, lines are collectively referred to as wiring, wiring patterns, electrodes, and electrode patterns.

The p-type electrode 40 of the semiconductor laser section is electrically connected to the semiconductor laser section current line LN3 through a wire W3, and the n-type electrode 30 of the semiconductor laser section is electrically connected to the grounding electrode 48 through a wire Wg1.

The p-type electrode 41 of the first EA modulator of the first EA modulator section 103 is electrically connected to the first modulation signal line LN1 through a wire W1 through the wire bonding pad 52 for the p-type electrode of the first EA modulator. The wire bonding pad 52 for the p-type electrode of the first EA modulator is electrically connected to a wire bonding pad 57 for the terminating resistor through a wire Wr1. The wire bonding pad 57 is electrically connected to one end of the first terminating resistor R1.

The n-type electrode 32 of the second EA modulator of the second EA modulator section 105 is electrically connected to the second modulation signal line LN2 through a wire W2 through the wire bonding pad 53 for the n-type electrode of the second EA modulator. The wire bonding pad 53 for the n-type electrode of the second EA modulator is electrically connected to a wire bonding pad 58 for the terminating resistor through a wire Wr2, and is also electrically connected to one end of the second terminating resistor R2.

The other end of the first terminating resistor R1 and the other end of the second terminating resistor R2 are electrically connected to a grounding electrode 49.

The first common electrode 45 is electrically connected to the n-type electrode 31 of the first EA modulator and the p-type electrode 42 of the second EA modulator through an electrode pattern or wire wiring. The first common electrode 45 is electrically connected to the wire bonding pad 51 for the first common electrode through an electrode pattern or wire wiring, and is also electrically connected to the grounding electrode 48 through a wire Wg2.

In the above description, the case of electrical connection between the electrode and the wire bonding pad by wire is exemplified. However, the optical modulator integrated semiconductor laser 700 may be mounted on the mounting substrate 200 or the like with a junction down, that is, the upper surface of the chip as the lower side, and electrically connected to each wiring pattern and each electrode of the optical modulator integrated semiconductor laser 700 by solder or gold ball.

FIG. 9B shows a configuration example of the optical transmission unit 1500 of a transceiver using the optical module 1000 according to Embodiment 3. The optical transmission unit 1500 of the transceiver includes: at least an optical module 1000; a wiring substrate 201, a monitor PD (photodiode) 90; an optical lens system 91; a wavelength multiplexer (WDM) 92; and an optical fiber 93.

The configuration of the optical module 1000 in FIG. 9B shows a more practical configuration example than that of FIG. 9A. Specifically, the grounding electrode 48 may be enlarged in order to join the optical modulator integrated semiconductor laser 700 to the mounting substrate 200 by die bonding, and the grounding electrode 48 may also be arranged under the optical modulator integrated semiconductor laser 700. The grounding electrode 48 may be connected to the ground on a rear surface of the mounting substrate 200 and grounded using a plurality of through electrodes 55 for grounding that penetrate the mounting substrate 200 and the side metallization. Moreover, in order to reduce the area of the mounting substrate 200, the first terminating resistor R1 and the second terminating resistor R2 may be connected to the grounding electrode 48 for grounding without providing the grounding electrode 49.

It is also possible to use the configuration of the optical module 1000 in the optical transmission unit 1500 of the transceiver may also be the configuration shown in FIG. 9A. Furthermore, in the configurations shown in FIGS. 9C, 10, 11, 12, 14A, 14B, 15, and 16, the grounding electrode 48 may be grounded to the ground of the rear surface of the mounting substrate 200, as shown in FIG. 9B, by mounting an optical modulator integrated semiconductor laser on the grounding electrode 48, or by electrically connecting the grounding electrode 48 to the plurality of through electrodes 55 that penetrates the mounting substrate 200 or to the side metallization provided on the side of the mounting substrate 200. In above-described configurations, the grounding electrode 48 may also be grounded by connecting the first terminating resistor R1 and the second terminating resistor R2 thereto without providing the grounding electrode 49.

A first modulation signal line La1 and a second modulation signal line La2 which are strip lines or coplanar lines for transmitting high-frequency signals on alumina or epoxy resin, and a semiconductor laser section current line La3 for supplying power to the DFB laser constituting the semiconductor laser section 101 are formed on the wiring substrate 201. The first modulation signal S1 and the second modulation signal S2 are respectively transmitted to the first modulation signal line La1 and the second modulation signal line La2 from an external EA modulator driver.

At least two wire bonding pads 57, 58 for the terminating resistor are provided on the mounting substrate 200. The first terminating resistor R1 and the second terminating resistor R2 are arranged so as to electrically connect the respective wire bonding pads 57, 58 for the terminating resistor to the grounding electrode 48.

As shown in FIG. 9B, the semiconductor laser section current line La3 on the wiring substrate 201, the semiconductor laser section current line LN3 on the mounting substrate 200, and the p-type electrode 40 of the semiconductor laser section are electrically connected in order through wires.

The first modulation signal line La1 on the wiring substrate 201, the first modulation signal line LN1 on the mounting substrate 200, the wire bonding pad 52 for the p-type electrode of the first EA modulator, and the wire bonding pad 57 for the terminating resistor electrically connected to the first terminating resistor R1 are electrically connected in order through wires.

Similarly, the second modulation signal line La2 on the wiring substrate 201, the second modulation signal line LN2 on the mounting substrate 200, the wire bonding pad 53 for the n-type electrode of the second EA modulator, and the wire bonding pad 58 for the terminating resistor electrically connected to the second terminating resistor R2 are electrically connected in order through wires.

The first common electrode 45 to which the n-type electrode 31 of the first EA modulator and the p-type electrode 42 of the second EA modulator are electrically connected is electrically connected to the grounding electrode 48 on the mounting substrate 200 through wires. The n-type electrode 30 of the semiconductor laser section is electrically connected to the grounding electrode 48 on the mounting substrate 200.

The monitor PD 90 monitors the light intensity emitted from the end surface of the optical modulator integrated semiconductor laser 700. The monitored light intensity is utilized to adjust the current flowing to the DFB laser, ensuring that the DFB laser constituting the semiconductor laser section 101 emits light at a constant light intensity.

The modulated light 80 emitted from the second EA modulator section 105 passes through the optical lens system 91 and the wavelength multiplexer 92, and then is coupled to the optical fiber 93. Although not shown in FIG. 9B, the light of a plurality of optical modulator integrated semiconductor lasers 700 having different oscillation wavelengths is combined into one by the wavelength multiplexer 92, and then is coupled to the optical fiber 93.

### <Operation of Optical Module According to Embodiment 3>

In the optical module 1000 according to Embodiment 3 shown in FIG. 9A, the first common electrode 45, to which the n-type electrode 30 of the semiconductor laser section, the n-type electrode 31 of the first EA modulator, and the p-type electrode 42 of the second EA modulator are electrically connected, is formed on the same side with the optical waveguide of the optical modulator integrated semiconductor laser 700 as a reference. In the following description, the line along the optical waveguide of the optical modulator integrated semiconductor laser 700 is referred to as a reference line. In other words, the semiconductor laser section 101, the first connecting waveguide section 102, the first EA modulator section 103, the second connecting waveguide section 104, and the second EA modulator section 105, which constitute the optical modulator integrated semiconductor laser 700, are sequentially arranged on the reference line along the optical waveguide.

In the case of the optical module 1000 according to Embodiment 3 shown in FIG. 9A, the n-type electrode 30 of the semiconductor laser section, the n-type electrode 31 of the first EA modulator, and the first common electrode 45 are formed on the side of the grounding electrode 48 with respect to the reference line. The n-type electrode 30 of the semiconductor laser section and the grounding electrode 48 are electrically connected through the wire Wg1. The first common electrode 45, to which the n-type electrode 31 of the first EA modulator and the p-type electrode 42 of the second EA modulator are electrically connected, is electrically connected to the grounding electrode 48 through the wire Wg2.

If electromagnetic waves radiated from the first modulation signal line LN1 and the second modulation signal line LN2 interfere with each wire that electrically connects the DFB laser and each EA modulator to the grounding electrode 48, an intensity noise may be superimposed on the optical modulation signals.

First, the wire Wg2 connecting the grounding electrode 48 and the wire bonding pad 51 for the first common electrode is required to be as short as possible to operate the EA modulator at high speed. This can be achieved by locating the grounding electrode 48 close to each EA modulator.

Next, in order to reduce electromagnetic waves radiated from the first modulation signal line LN1 and the second modulation signal line LN2, and also for high-speed operation, it is important to shorten the lengths of the wire W1, W2 as much as possible. For this purpose, the first modulation signal line LN1 and the second modulation signal line LN2 are required to be routed as close as possible to each EA modulator of the optical modulator integrated semiconductor laser 700.

Here, if the grounding electrode 48, the first modulation signal line LN1, and the second modulation signal line LN2 are arranged on the same side with respect to the reference line, the first modulation signal line LN1 and the second modulation signal line LN2 need to be located apart from each EA modulator by the size of the grounding electrode 48. In addition, since the distance between the wires W1, W2 and the wire Wg2 is close, the electromagnetic interference tends to occur.

Conversely, if the grounding electrode 48 is arranged on the opposite side of the first modulation signal line LN1 and the second modulation signal line LN2 with respect to the reference line, the first modulation signal line LN1 and the second modulation signal line LN2 can be arranged closer to each EA modulator, and the distance between the wires W1, W2 and the wire Wg2 can be separated, thereby the electromagnetic interference is less likely to occur than if they are arranged on the same side. That is, it is preferable that the grounding electrode 48 is arranged on the opposite side of the first modulation signal line LN1 and the second modulation signal line LN2 with respect to the reference line.

Next, in Embodiment 3, since the DFB laser is formed on the semi-insulating Fe-doped InP substrate 1a instead of the conductive n-type InP substrate 1, the DFB laser is grounded using a wire. It is also advantageous to make the wire Wg1 as short as possible to suppress electromagnetic interference, and it is preferable to locate the grounding electrode 48 as close as possible to the DFB laser. In this case, if the grounding electrode 48 for grounding the wire Wg1 is arranged on the opposite side of the first modulation signal line LN1 and the second modulation signal line LN2 with respect to the reference line, the distance between the wires W1, W2 and the wire Wg1 can be separated, thereby electromagnetic interference is less likely to occur than if they are arranged on the same side.

As a countermeasure against such a problem, in the optical module 1000 according to Embodiment 3 shown in FIG. 9A, the n-type electrode 30 of the semiconductor laser section, the n-type electrode 31 of the first EA modulator, the p-type electrode 42 of the second EA modulator and the first common electrode 45 electrically connected to these electrodes are formed on the same side with respect to the reference line, thereby each wire electrically connected to the grounding electrode 48 can be connected with the shortest distance, that is, with the shortest wire length.

The chip thickness of the optical modulator integrated semiconductor laser 700 is about 100 μm, thereby short-length wire wiring of 300 μm or less is possible. Thus, the inductance of each wire is 0.2 nH or less, so that electromagnetic interference can be suppressed even in a 100 GHz broadband modulation.

Furthermore, by arranging the first common electrode 45, which electrically connects the n-type electrode 31 of the first EA modulator and the p-type electrode 42 of the second EA modulator, on the opposite side of the first modulation signal line LN1 and the second modulation signal line LN2 with respect to the reference line, the amount of electromagnetic interference generated from each modulation signal line can be reduced. Similarly, by arranging the n-type electrode 30 of the semiconductor laser section on the opposite side the first modulation signal line LN1 and the second modulation signal line LN2 with respect to the reference line, the amount of electromagnetic interference generated from each modulation signal line can be reduced. Furthermore, although a plurality of optical modulator integrated semiconductor lasers 700 having different oscillation wavelengths are mounted on the optical transmission unit 1500 of the transceiver, the amount of electromagnetic interference between the plurality of optical modulator integrated semiconductor lasers 700 can be reduced.

As in the optical modulator integrated semiconductor laser 760 and the optical module 1010 shown in FIG. 9C, without providing the first common electrode 45 electrically connected to the n-type electrode 31 of the first EA modulator and the p-type electrode 42 of the second EA modulator on the chip, it is also possible to electrically connect the n-type electrode 31 of the first EA modulator and the p-type electrode 42 of the second EA modulator directly to the grounding electrode 48 by a wire or solder in an electrode pattern on the mounting substrate 200, and to use the grounding electrode 48 as the common electrode. The n-type electrode 31 of the first EA modulator is electrically connected to the grounding electrode 48 through the wire Wg3 through the wire bonding pad 54 for the n-type electrode of the first EA modulator.

In the present disclosure, an electrode pattern in which the n-type electrode 31 of the first EA modulator and the p-type electrode 42 of the second EA modulator are electrically connected on the optical modulator integrated semiconductor laser 700, an electrode pattern in which the n-type electrode 31 of the first EA modulator and the p-type electrode 42 of the second EA modulator are electrically connected on the mounting substrate 200, and a wiring pattern in which the n-type electrode 31 of the first EA modulator and the p-type electrode 42 of the second EA modulator are connected by a wire are collectively referred to as “first common electrode”.

Note that electrically connecting the n-type electrode 31 of the first EA modulator and the p-type electrode 42 of the second EA modulator on the mounting substrate 200 reduces the electrical interference between the first EA modulator 103 and the second EA modulator 105.

### <Effects of Embodiment 3>

The effect of the optical modulator integrated semiconductor laser 700 mounted on the optical module 1000 according to Embodiment 3 will be described below. The optical modulator integrated semiconductor laser 700 mounted on the optical module 1000 according to Embodiment 3 has the same effect as the optical modulator integrated semiconductor laser 500 according to Embodiment 1. The optical modulator integrated semiconductor laser 700 has the effect of further reducing electromagnetic interference.

In the optical modulator integrated semiconductor laser 700 mounted on the optical module 1000 according to Embodiment 3, the first common electrode 45 for electrically connecting the n-type electrode 30 of the semiconductor laser section, the n-type electrode 31 of the first EA modulator, and the p-type electrode 42 of the second EA modulator is formed on the same side with respect to the reference line, thereby the length of the wire for electrically connecting the first common electrode 45 and the grounding electrode 48 can be shortened, thus providing an effect of suppressing the intensity noise of light intensity due to electromagnetic interference. As a result, the effect of canceling the fluctuation of the light intensity between the first EA modulator section 103 and the second EA modulator section 105 is improved, thus providing an effect of achieving an optical modulator integrated semiconductor laser that enables broadening of the bandwidth, high-density mounting, and simplification of error rate correction circuits for optical transceivers.

### Modification 1 of Embodiment 3

### <Configuration of Optical Modulator Integrated Semiconductor Laser and Optical Module According to Modification 1 of Embodiment 3>

An optical modulator integrated semiconductor laser 800 and an optical module 1020 according to Modification 1 of Embodiment 3 are characterized in that, compared with Embodiment 3, the first common electrode 45, to which the n-type electrode 31 of the first EA modulator and the p-type electrode 42 of the second EA modulator of the optical modulator integrated semiconductor laser 800 are electrically connected, is extended to the front and rear end sides, and thus wire bond spaces Ws1, Ws2 are provided at both ends of the extended first common electrode 45b.

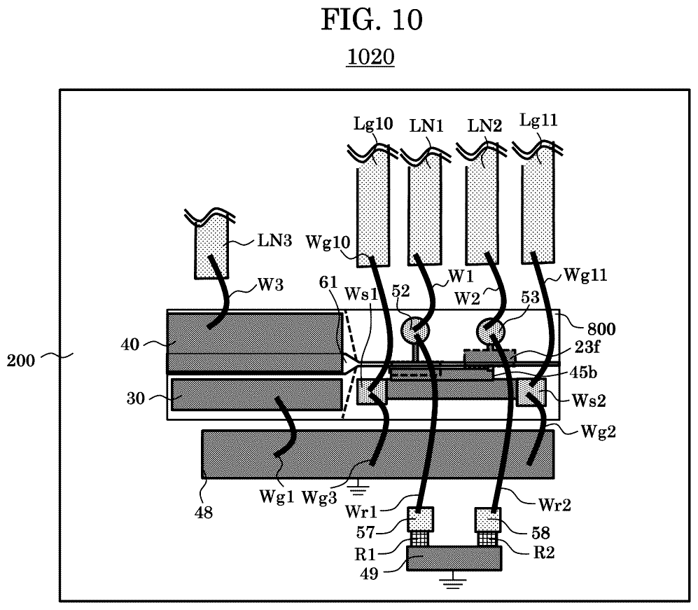

As shown in the top view of FIG. 10, the wire bond space Ws2 on the front end side of the first common electrode 45 is located closer to the front end side than the wire bonding pad 53 for the n-type electrode of the second EA modulator. The wire bond space Ws1 on the rear end side of the first common electrode 45 is located closer to the rear end side than the wire bonding pad 52 for the p-type electrode of the first EA modulator.

Ground lines Lg10, Lg11 are provided outside the first modulation signal line LN1 and the second modulation signal line LN2 of the optical module 1020, respectively. The ground line Lg10 on the side of the first modulation signal line LN1 is connected by wires Wg10, Wg3 to the grounding electrode 48 on the mounting substrate 200 through the wire bond space Ws1 on the rear end side of the first common electrode 45. The ground line Lg11 on the side of the second modulation signal line LN2 is connected by wires Wg11, Wg2 to the grounding electrode 48 on the mounting substrate 200 through the wire bond space Ws2 on the rear end side of the first common electrode 45.

The p-type electrode 40 of the semiconductor laser section is electrically connected to the semiconductor laser section current line LN3 through the wire W3, and the n-type electrode 30 of the semiconductor laser section is electrically connected to the grounding electrode 48 through the wire Wg1. The p-type electrode 41 of the first EA modulator of the first EA modulator section 103 is electrically connected to the first modulation signal line LN1 and the first terminating resistor R1 through the wires W1, Wr1. The n-type electrode 32 of the second EA modulator of the second EA modulator section 105 is electrically connected to the second modulation signal line LN2 and the second terminating resistor R2 through the wires W2, Wr2.

### <Operation of Optical Modulator Integrated Semiconductor Laser and Optical Module According to Modification 1 of Embodiment 3>

The impedance of the wires is high, thereby it tends to radiate electromagnetic waves when a high-frequency signal is input. In the optical modulator integrated semiconductor laser 800 according to Modification 1 of Embodiment 3, the wires Wg10, Wg11 are arranged outside the wire W1, which is connected to the first modulation signal line LN1, and the wire W2, which is connected to the second modulation signal line LN2, thereby radiation of electromagnetic waves from the wires W1, W2 is suppressed. Similarly, the wires Wg2, Wg3, which electrically connect the ground lines Lg10, Lg11 and the grounding electrode 48 through the wire bond spaces Ws1, Ws2 of the first common electrode 45, are provided outside the wires Wr1, Wr2, which connect the p-type electrode 41 of the first EA modulator and the n-type electrode 32 of the second EA modulator, respectively, thereby radiation of electromagnetic waves from the wires Wr1, Wr2 is suppressed.

### Effects of Modification 1 of Embodiment 3

As described above, the optical module according to Modification 1 of Embodiment 3 is configured to sandwich the outside of the wires W1, Wr1, W2, and Wr2, which are electrically connected to the two modulation signal lines, with the wires Wg10, Wg3, Wg11, and Wr2, which are electrically connected to the ground lines Lg10, Lg11, respectively, thereby radiation of electromagnetic waves generated in the modulation signal lines can be suppressed, thus providing an effect of preventing external electromagnetic waves from coupling into the modulation signal lines.

The impedance of the wire portion increases, causing reflection of high-frequency signals, but the coupling of the electromagnetic field with the parallel wires electrically connected to the ground lines Lg10, Lg11 has the effect of reducing the impedance. As a result, the reflection of the high-frequency signal is reduced, thus providing an effect of achieving an optical module that can be used for broadband applications.

### Modification 2 of Embodiment 3

### <Structure of Optical Modulator Integrated Semiconductor Laser and Optical Module According to Modification 2 of Embodiment 3>

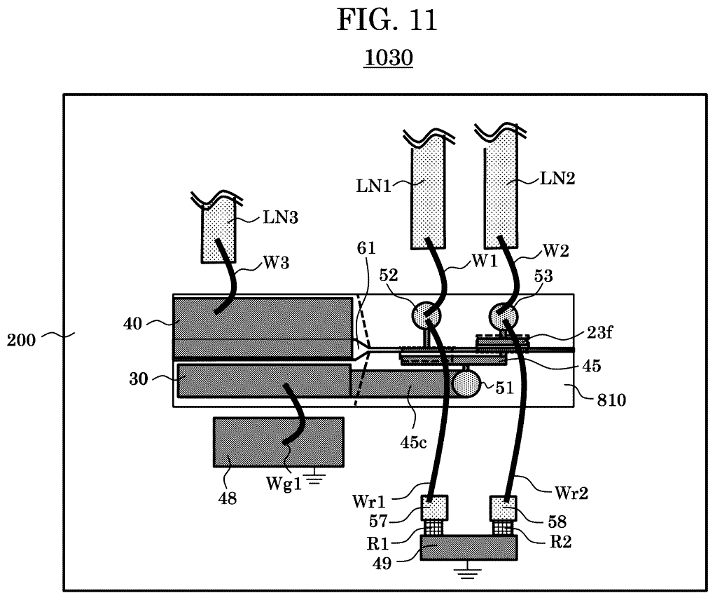

In an optical modulator integrated semiconductor laser 810 according to Modification 2 of Embodiment 3, the n-type electrode 30 of the semiconductor laser section, the n-type electrode 31 of the first EA modulator, and the p-type electrode 42 of the second EA modulator are electrically connected to the first common electrode 45, respectively, as shown in the top view shown in FIG. 11. Thus, the number of wires electrically connected between the n-type electrode 30 of the semiconductor laser section, the first common electrode 45, and the grounding electrode 48 can be reduced. Other structures of the optical modulator integrated semiconductor laser 810 according to Modification 2 of Embodiment 3 are the same as those of the optical modulator integrated semiconductor laser 700 according to Embodiment. The action and effect of the optical modulator integrated semiconductor laser 810 according to Modification 2 of Embodiment 3 are the same as those of the optical modulator integrated semiconductor laser 700 according to Embodiment 2.

An optical module 1030 according to Modification 2 of Embodiment 3 has the optical modulator integrated semiconductor laser 810 mounted on the mounting substrate 200. The action and effect of the optical module 1030 according to Modification 2 of Embodiment 3 are the same as those of the optical module 1000 according to Embodiment 3.

### Modification 3 of Embodiment 3

### <Configuration of Optical Modulator Integrated Semiconductor Laser and Optical Module According to Modification 3 of Embodiment 3>

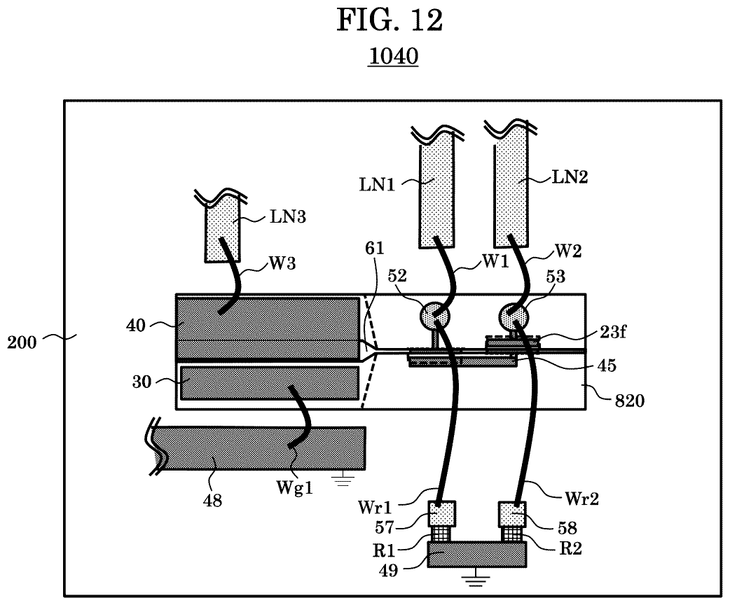

As shown in the top view of FIG. 12, an optical module 1040 according to Modification 3 of Embodiment 3 uses an optical modulator integrated semiconductor laser 820. The structural difference between the optical modulator integrated semiconductor laser 820 and the optical modulator integrated semiconductor laser 700 is only the presence or absence of the wire bonding pad 51 for the first common electrode.

In the optical module 1040 according to Modification 3 of Embodiment 3, the e first common electrode 45 electrically connected to the n-type electrode 31 of the first EA modulator and the p-type electrode 42 of the second EA modulator of the optical modulator integrated semiconductor laser 820 is not electrically connected to the grounding electrode 48 by a wire.

The optical module 1040 according to Modification 3 of Embodiment 3 has the optical modulator integrated semiconductor laser 820 mounted on the mounting substrate 200.

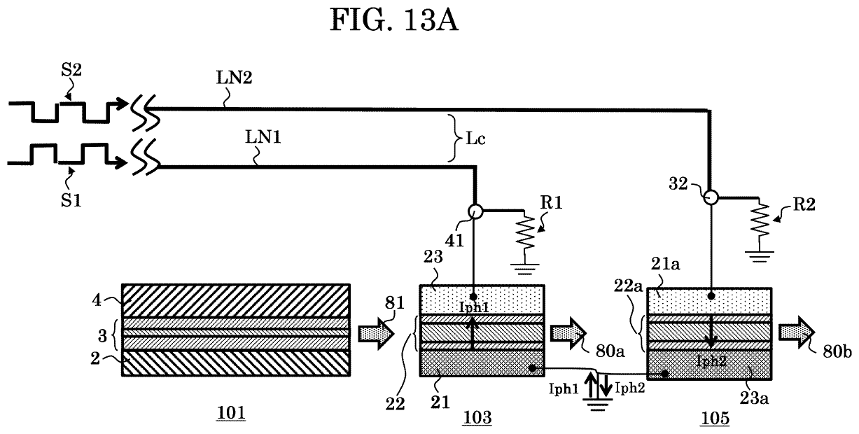

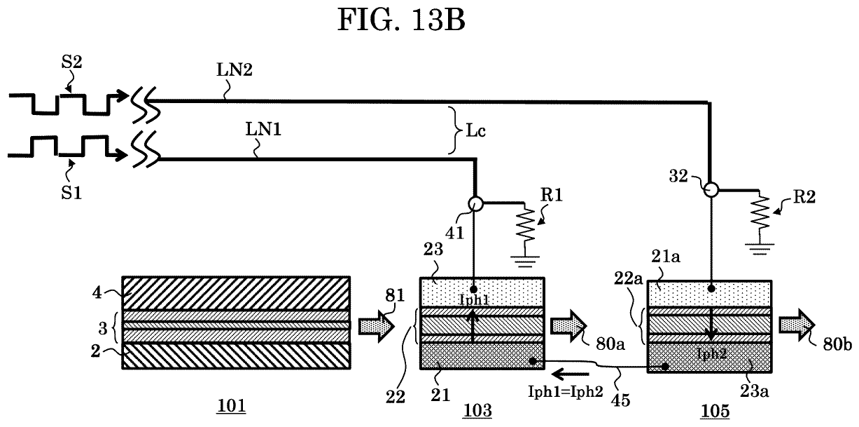

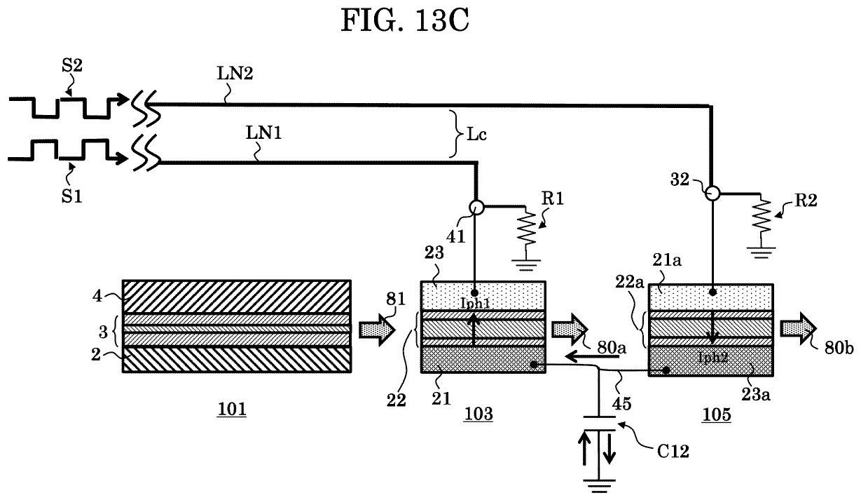

The effect of the configuration in which the first common electrode 45 is not electrically connected to the grounding electrode 48 will be described with reference to the schematic diagrams of FIGS. 13A and 13B. In FIGS. 13A and 13B, Iph1 and Iph2 represent the photocurrent generated by the light absorption of the first EA modulator section 103 and the photocurrent generated by the light absorption of the second EA modulator section 105, respectively.

FIG. 13A is a schematic diagram for explaining the case where the first common electrode is grounded. In the case where the first common electrode is grounded, Iph1 and Iph2 flow to the grounding electrode 48, thus there is no problem whether the two photocurrent values are the same (Iph1=Iph2) or different (Iph1≠Iph2).

FIG. 13B is a schematic diagram for explaining the case where the first common electrode is not grounded. In the case where the first common electrode is not grounded, the photocurrent flowing through the first common electrode is required to be Iph1=Iph2. In the EA modulator, the amount of light absorption, that is, the photocurrent, changes depending on the bias voltage applied in the reverse direction of the p-n junction. Accordingly, in the case of FIG. 13B, the average bias voltage applied to the p-n junction of the first EA modulator section 103 and the average bias voltage applied to the p-n junction of the second EA modulator section 105 are automatically adjusted such that Iph1=Iph2.

The above will be explained with specific examples. In FIG. 13B, it is assumed that +1 V is applied to the n-type electrode 32 of the second EA modulator of the second EA modulator section 105 and −1 V is applied to the p-type electrode 41 of the first EA modulator of the first EA modulator section 103. In the case where no light is incident on each EA modulator, the reverse voltage V1=1 V is applied to the p-n junction of the first EA modulator section 103 and the reverse voltage V2=1 V is applied to the p-n junction of the second EA modulator section 105.

Here, V1+V2=2 V=constant. When light is incident on the first EA modulator section 103, the light is absorbed and attenuated in the first EA modulator section 103, thus reducing the amount of light that enters the second EA modulator section 105, and the photocurrent flowing through the second EA modulator section 105 becomes smaller (Iph1>Iph2). Accordingly, in order to make Iph1=Iph2, the voltage applied to the p-n junction of each EA modulator changes such that V1<V2, resulting in an automatic change in the voltage distribution of V1 and V2 such that Iph1 decreases and Iph2 increases. Note that, V1+V2=2V=constant is maintained.

As described above, the first common electrode electrically connected to the n-type electrode 31 of the first EA modulator and the p-type electrode 42 of the second EA modulator is not grounded, thereby the current flowing through each EA modulator is the same (Iph1=Iph2), that is, equal. As a result, even when a large amount of light is incident, only the first EA modulator section 103 does not become hot or generate heat due to the photocurrent, thus providing an effect of improving reliability of an optical modulator integrated semiconductor laser.

The photocurrent flowing through the first EA modulator section 103 is the total current of the DC component Iph1(DC) and the high-frequency component Iph1(RF). That is, the photocurrent Iph1 of the first EA modulator section 103 and the photocurrent Iph2 of the second EA modulator section 105 are expressed by the following Expressions (18) and (19), respectively.

Iph1=Iph1(DC)+Iph1(RF) (18)

Iph2=Iph2(DC)+Iph2(RF) (19)

When the average photocurrent, that is, the DC components Iph1(DC) and Iph2(DC), increase, the EA modulator becomes hot due to the influence of the photocurrent and thus generates heat. Consequently, when the state represented by the following Expression (20) is achieved, the first EA modulator section 103 and the second EA modulator section 105 generate heat equally, and thus the reliability of the optical modulator integrated semiconductor laser is improved.

Iph1(DC)=Iph2(DC) (20)

On the other hand, in the case where the fluctuation in the amount of transmitted light in the first EA modulator section 103 due to electromagnetic interference is canceled out by the second EA modulator section 105, it is required that Iph1(RF)≠Iph2(RF).

As shown in the schematic diagram of FIG. 13C, if the first common electrode 45 is grounded through the capacitor C12, the DC component of the photocurrent of each EA modulator can be made the same. Furthermore, since the high-frequency component of the photocurrent flows to the grounding electrode 48 through the capacitor C12, the high-frequency interference can be canceled by the two EA modulators, thus providing an effect of achieving an optical modulator integrated semiconductor laser which has excellent reliability and is not susceptible to electromagnetic interference.

### Modification 4 of Embodiment 3

### <Optical Module According to Modification 4 of Embodiment 3>

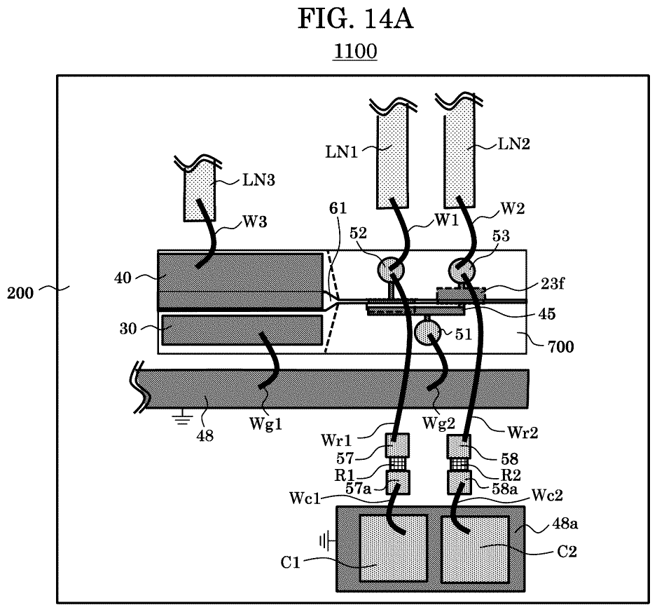

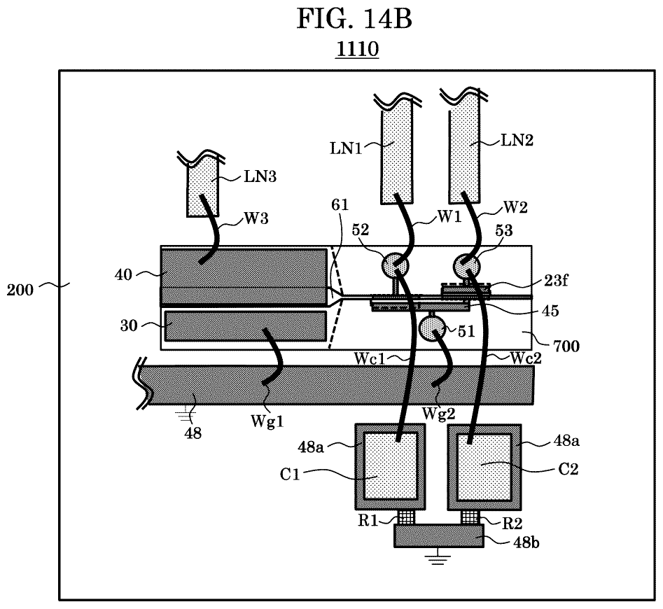

An optical module 1100 according to Modification 4 of Embodiment 3 will be described with reference to the top view of FIG. 14A. In the optical module 1100 according to Modification 4 of Embodiment 3, a wire bonding pad 57 for the terminating resistor and a wire bonding pad 57a for the capacitor are respectively provided at both ends of the first terminating resistor R1. The wire bonding pad 57 for the terminating t resistor is electrically connected to the p-type electrode 41 of the first EA modulator through a wire Wr1. The wire bonding pad 57a for the capacitor is electrically connected to the upper surface of a capacitor C1 for the first EA modulator through a wire Wc1.

Similarly, a wire bonding pad 58 for the terminating resistor and a wire bonding pad 58a for the capacitor are provided at both ends of the second terminating resistor R2, respectively. The wire bonding pad 58 for the terminating resistor is electrically connected to the n-type electrode 32 of the second EA modulator through a wire Wr2. The wire bonding pad 58a for the capacitor is electrically connected to the upper surface of the capacitor C2 for the second EA modulator through a wire Wc2. The lower surface of each capacitor is electrically connected to the grounding electrode 48a.

As shown in FIG. 4, DC voltages of −1 V are applied to the p-type electrode 41 of the first EA modulator of the first EA modulator section 103, and +1 V are applied to the n-type electrode 32 of the second EA modulator of the second EA modulator section 105. Consequently, in the case of Embodiment 3 (FIGS. 9A-9C), DC current flows through the first terminating resistor R1 and the second terminating resistor R2, which are grounded. If each terminating resistor is set to 50Ω, a total DC current of 40 mA is consumed, which is twice as much as the comparative example shown in FIG. 2.

As shown in FIG. 14A, when a capacitor is inserted in series with the terminating resistor of each EA modulator, DC current does not flow. As for the canceling effect of electromagnetic interference, it has no adverse effect because the current flows through the capacitor. In the optical module 1100 shown in FIG. 14A, each EA modulator, each terminating resistor, each capacitor, and the grounding electrode 48a are electrically connected in this order. But as in an optical module 1110 shown in FIG. 14B, each EA modulator, each capacitor, each terminating resistor, and the grounding electrode 48a may be electrically connected in this order. In the case of FIG. 14B, the number of wires is one less each than in the case of FIG. 14A, thereby electromagnetic interference can be suppressed.

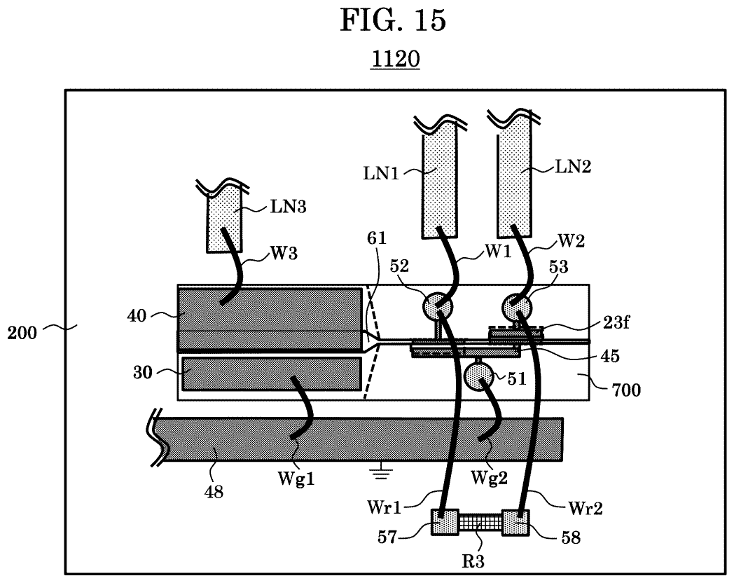

Furthermore, as in an optical module 1120 shown in FIG. 15, the terminating resistor may be located as a third terminating resistor R3 between the wire Wr1 of the p-type electrode 41 of the first EA modulator and the wire Wr2 of the n-type electrode 32 of the second EA modulator without grounding. The optical module 1120 has the effect of eliminating the need for a grounding electrode.

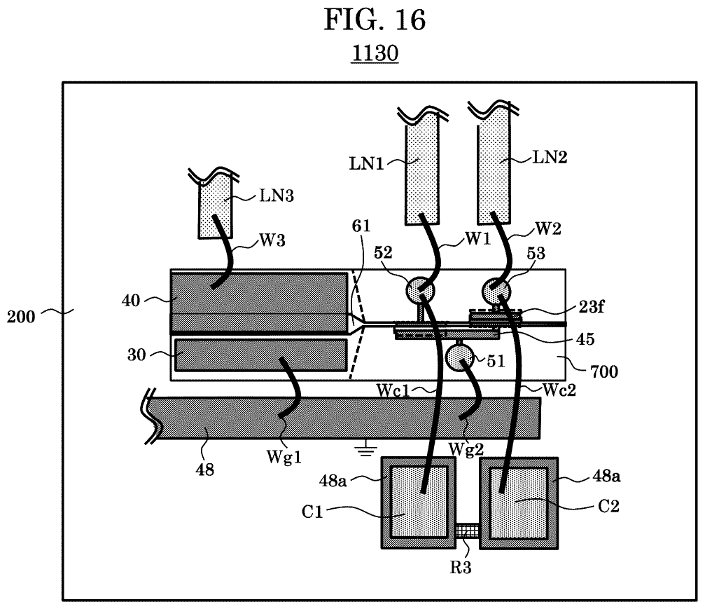

Furthermore, as in an optical module 1130 shown in FIG. 16, the capacitor C1 for the first EA modulator and the capacitor C2 for the second EA modulator may be located between the third terminating resistor R3, which is the terminating resistor of each EA modulator, and the wires Wc1, Wc2, respectively. The arrangement of the capacitors to prevent DC current caused by the DC voltage difference between the p-type electrode 41 of the first EA modulator and the n-type electrode 32 of the second EA modulator has the effect of reducing the power consumption of the optical module. Note that the resistance value of the third terminating resistor R3 is required to be twice, for example 100Ω, that of the resistor in the case of single-phase drive.

### Embodiment 4

### <Configuration of Multi-Level Intensity Modulation Transceiver According to Embodiment 4>

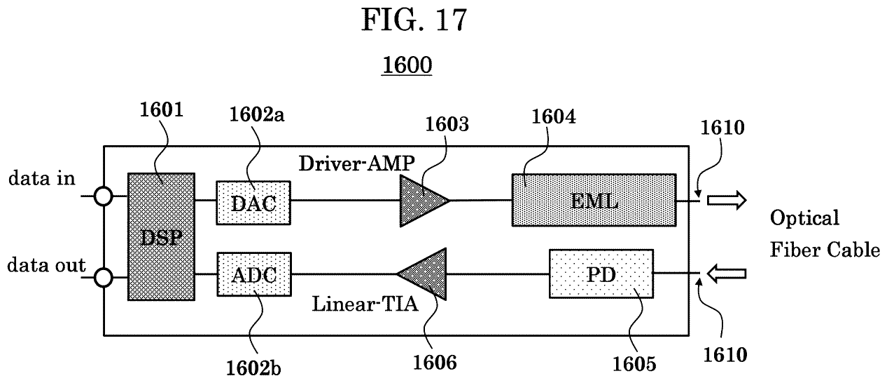

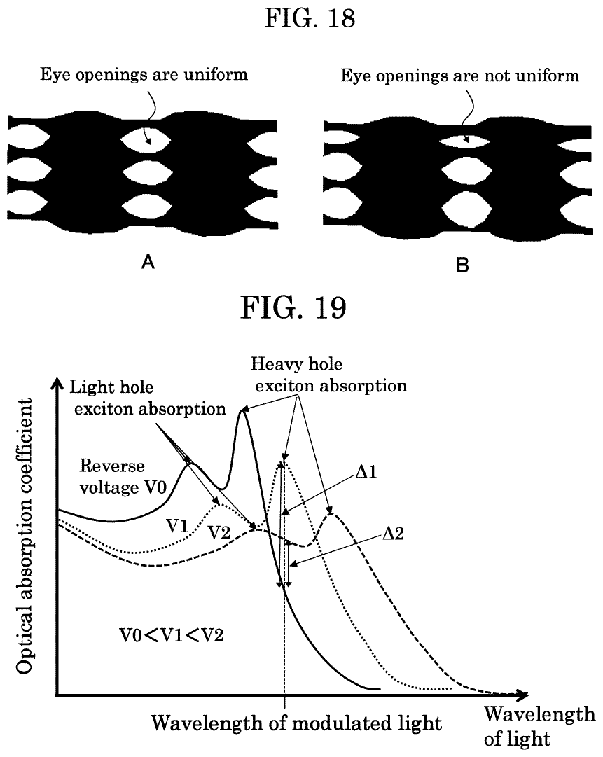

FIG. 17 is a diagram showing the configuration of a multi-level intensity modulation transceiver 1600 according to Embodiment 4. FIGS. 18A and 18B are diagrams showing received waveforms of the multi-level intensity modulation transceiver 1600 according to Embodiment 4.

The multi-level intensity modulation transceiver 1600 according to Embodiment 4 is a multi-level intensity modulation transceiver of the PAM (Pulse Amplitude Modulation) system which is a multi-level intensity modulation system. In a transmitting unit, a digital signal generated by a DSP (Digital Signal Processor) 1601, which is a digital signal processing circuit, is analog-converted by a DAC (Digital-to-Analog Converter) 1602a, then amplified by the Driver-AMP (Driver Amp) 1603, and an optical signal are emitted to an optical fiber cable 1610 through the optical system by driving an optical modulator integrated semiconductor laser 1604.

In a receiving unit, the optical signal is inputted from the optical fiber cable 1610 through the optical system to the PD (Photodiode) 1605, which is a semiconductor light receiving device, and then converts and multiplies the optical signal into a current. Furthermore, after the optical signal is amplified by a Linear-TIA (Trans Impedance Amplifier) 1606, the optical signal is converted into digital signal by the ADC (Analog-to-Digital Converter) 1602b, and then the digital signal is processed by the DSP 1601.

The optical modulator integrated semiconductor laser 1604 of the present disclosure is the optical modulator integrated semiconductor laser includes: the semiconductor laser section 101; the first connecting waveguide section 102; the first EA modulator section 103; the second connecting waveguide section 104; and the second EA modulator section 105 as described in Embodiment 1, Modification of Embodiment 1, Embodiments 2 to 3, and Modifications 1 to 4 of Embodiment 3.

In FIG. 17, only one wavelength configuration (one set) is described, but in the multi-level intensity modulation transceiver 1600, four or eight wavelength multiplexing is usually performed, so that four or eight sets are mounted at high-density.

### <Operation of Multi-Level Intensity Modulation Transceiver According to Embodiment 4>

In the multi-level intensity modulation transceiver 1600 of the PAM system (FIG. 17), it is necessary to receive not only binary signals of one and zero, such as NRZ (None Return to Zero) and RZ (Return to Zero), but also, for example, four values with different optical signal intensities in the PAM4.

FIG. 18A shows a conceptual diagram of the received waveform of the PAM4. An index called TDECQ (Transmitter Dispersion and Eye Closure Quaternary) is used to determine whether the received waveform is good or bad in the case of PAM4. TDECQ is calculated by the following Expression (21).

TDECQ (dB)=10×log(OMA/(6×Qt×R)) (21)

In Expression (21), the optical modulation amplitude (OMA) is the total amplitude from level zero to level three, Qt is a value that depends on the SER (Symbol Error Rate) specified by IEEE (Institute of Electrical and Electronics Engineers), and R is an additional noise value required to achieve the SER value. TDECQ (dB) is specified to be, for example, 3 dB or less.

In order to reduce TDEQ (dB), the following conditions are required.

(1) Condition A: The eye aperture of each level is large and uniform.
(2) Condition B: The noise of each level is small.

In order for the eye aperture of each level consisting of four values with different signal intensities of light under Condition A to be uniform, the linearity of the optical modulator integrated semiconductor laser 1604 as the transmission light source is required to be excellent. Here, the excellent linearity of the optical modulator integrated semiconductor laser 1604 means that the following Expression (22) is satisfied, when the change in the applied voltage to the EA modulator is denoted by ΔV and the amount of fluctuating light transmitted through the EA modulator is denoted by ΔP.

ΔP/ΔV=constant (22)

Furthermore, since the PAM4 modulates with four values, the dynamic range is required to be excellent. Here, the excellent dynamic range means that the relationship in Expression (22) is maintained even when the change in the applied voltage, that is, the voltage amplitude ΔV, is increased to 0.5 V, 1.0 V, 1.5 V, for example. As shown in the receiving waveform B in FIG. 18, which is a conceptual diagram showing the received waveform of the multi-level intensity modulation transceiver 1600, when the linearity and dynamic range deteriorate, the eye aperture formed between the level two and the level three deteriorates. FIG. 19 shows a conceptual diagram of the wavelength dependence of the optical absorption coefficient in the case where voltage is applied to the MQW layer. The EA modulator extinguishes light by utilizing the quantum Stark effect, in which the wavelength of the MQW layer's exciton absorption shifts to the longer wavelength side when voltage is applied, and the optical absorption coefficient at long wavelengths increases, as shown in FIG. 19.

However, when the reverse voltage V0 is increased to V1 at the wavelength of the modulated light 80, the amount of change A1 in the optical absorption coefficient increases, but when the reverse voltage is further increased to V2, the amount of change 42 in the optical absorption coefficient decreases. That is, the extinction ratio depending on the amount of change in the optical absorption coefficient decreases when the reverse voltage is too high. Therefore, there is an optimum range for the modulation voltage amplitude Vpp, and the linearity is better when Vpp is as small as possible.

As shown in Embodiment 1, in the optical modulator integrated semiconductor laser according to the present disclosure, the two EA modulators are operated with single-phase voltage signals, thereby a high extinction ratio can be obtained, and the modulation voltage amplitude Vpp of each EA modulator can be reduced, resulting in excellent linearity. Therefore, the eye aperture becomes uniform as shown in A of FIG. 18, which is a conceptual diagram showing the received waveform of the multi-level intensity modulation transceiver 1600.

In order to reduce the noise at each level of Condition B, it is necessary to cancel out the fluctuation of the amount of transmitted light of the first EA modulator section 103 due to the electromagnetic interference using the second EA modulator section 105 as in Embodiment 1. The optical modulator integrated semiconductor laser according to the present disclosure has excellent linearity because Vpp can be reduced as described above.

As shown in the schematic diagram of FIG. 4, it is assumed that electromagnetic waves of the same magnitude are applied to the first modulation signal line LN1 and the second modulation signal line LN2 simultaneously, and the bias voltage of the first EA modulator section 103 changes by +ΔV and the bias voltage of the second EA modulator section 105 changes by −ΔV. The changes in the amount of transmitted light of the first EA modulator section 103 and the second EA modulator section 105 in this case are assumed to be +ΔP1 and −ΔP2, respectively. If the linearity is poor and the extinction amount of the EA modulator decreases as the reverse voltage increases, then ΔP1>ΔP2. As a result, the fluctuating light intensity ΔP after passing through the two EA modulators fluctuates by the amount expressed in the following Expression (23).

ΔP=ΔP1−ΔP2 (23)

In order to set the fluctuation light amount ΔP=0, the following Expression (24) is required to be satisfied.

ΔP1/ΔV=ΔP2/ΔV (24)

As described above, since Vpp can be reduced in the present disclosure, linearity is excellent as expressed by Expression (24). Therefore, the effect of canceling out electromagnetic interference is high.

### Effects of Embodiment 4

As described above, in the multi-level intensity modulation transceiver according to Embodiment 4, the optical modulator integrated semiconductor laser according to Embodiment 1 is used as a light source of the multi-level intensity modulation transceiver, thereby linearity of the optical output is excellent and the fluctuation of the transmitted light amount due to electromagnetic interference is small. Therefore, in multi-level intensity modulation such as PAM4, a modulation waveform with uniform eye aperture at each level and small noise can be achieved. As a result, TDECQ, which is an index of the waveform quality, is improved, thus providing an effect of achieving a multi-level intensity modulation transceiver which enables broadening of the optical transceiver, high-density mounting, and simplification of the error rate correction circuit.

### Embodiment 5

### <Configuration of Optical Line Terminating Device According to Embodiment 5>

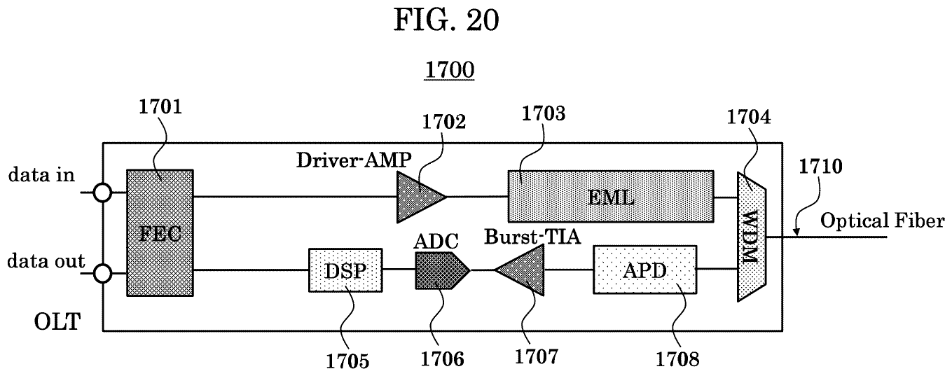

FIG. 20 is a schematic diagram showing an optical line terminating device (OLT) 1700 on the station side of a 50G-PON system according to Embodiment 5. The optical line terminating device 1700 according to Embodiment 5 converts input data into a modulation signal using an optical modulator integrated semiconductor laser 1703 according to the present disclosure through a FEC (Forward Error Correction) 1701 and a driver amplifier 1702. The modulation signal pass through an WDM (Wavelength Division Multiplexing) 1704 and the optical system, and is coupled to an optical fiber cable 1710.

The modulation signal transmitted by the optical fiber cable 1710 is converted into a current signal by a semiconductor photodetector such as an APD 1708 (Avalanche Photodiode) or a PD through the optical system and the WDM 1704. The current signal passes through a burst TIA (Trans Impedance Amplifier) 1707, an ADC 1706, which is an analog/digital conversion circuit, and a DSP 1705, which is a digital signal processing circuit, and is corrected by a FEC 1701 to output the data.

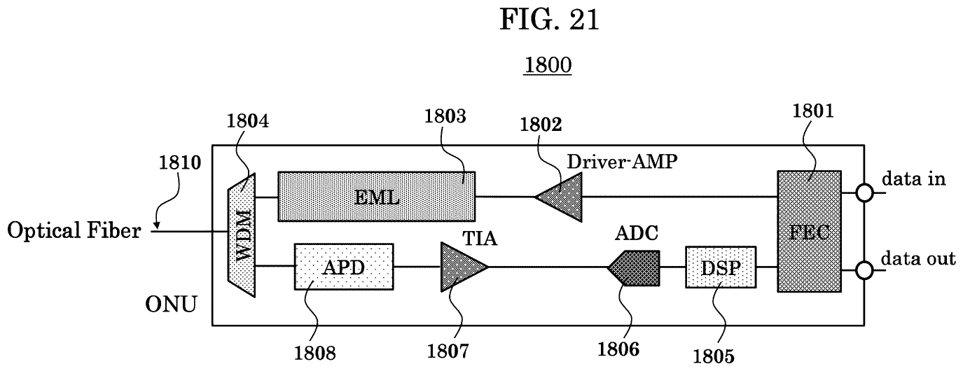

FIG. 21 is a schematic diagram showing the optical line terminating device (ONU) 1800 on a subscriber side of the 50G-PON system according to Embodiment 5. The optical line terminating device 1800 according to Embodiment 5 converts input data into an optical modulation signal using the optical modulator integrated semiconductor laser 1803 through a FEC 1801 and a driver amplifier 1802. The optical modulation signal pass through a WDM 1804 and the optical system, and is coupled to the optical fiber cable 1810.

The optical modulation signal transmitted from the optical fiber cable 1810 are converted into a current signal by a photodetector such as an APD 1808 or a PD through the optical system and the WDM 1804. The current signal passes through the TIA 1807, the ADC 1806, which is an analog/digital conversion circuit, and a DSP 1805, which is a digital signal processing circuit, and then is corrected for errors in the FEC 1801 and the data is output.

The optical modulator integrated semiconductor laser 1803 according to the present disclosure is the optical modulator integrated semiconductor laser comprising the DFB laser, the first connecting waveguide section 102, the first EA modulator section 103, the second connecting waveguide section 104, and the second EA modulator section 105 as described in Embodiment 1, Modification of Embodiment 1, Embodiments 2 to 3, and Modifications 1 to 2 of Embodiment 3.

### <Action of Optical Line Terminating Device According to Embodiment 5>

As shown in FIGS. 20 and 21, electronic circuits such as the DSP and the FEC that perform signal processing at high-speed are mounted on the OLT and the ONU. In particular, since broadband signal processing is required in the next generation 50G-PON, electromagnetic interference may occur in the OLT and the ONU. As described in Embodiment 1, in the optical modulator integrated semiconductor laser according to the present disclosure, the electromagnetic interference is canceled by the first EA modulator 103 and the second EA modulator 105, so that the signal error rate does not deteriorate. Therefore, the circuit configuration of the FEC, which corrects the signal error, and the DSP, which reduces the influence of the noise, can be simplified, thus providing an effect of reducing the power consumption.

### Effects of Embodiment 5

As described above, in the optical line terminating device according to Embodiment 5, the optical modulator integrated semiconductor laser of the present disclosure is used as a light source, thus providing an effect of achieving a station-side optical line terminating device (OLT) and a subscriber-side optical line terminating device (ONU) with small power consumption.

In particular, as in Modification of Embodiment 1, it is possible to reverse the polarity of the semiconductor layers electrically connected by the common electrodes in Embodiments other than Modification of Embodiment 1. In each of Embodiments other than Modification of Embodiment 1, it is possible to replace the terms as follows.

(1) the p-type electrode of the first EA modulator (p-type semiconductor layer)→the n-type electrode of the first EA modulator (n-type semiconductor layer)
(2) the n-type electrode of the second EA modulator (n-type semiconductor layer)→the p-type electrode of the second EA modulator (p-type semiconductor layer)
(3) the first common electrode electrically connected to the n-type electrode of the first EA modulator (n-type semiconductor layer) and the p-type electrode of the second EA modulator (p-type semiconductor layer)→the second common electrode electrically connected to the p-type electrode of the first EA modulator (p-type semiconductor layer) and the p-type electrode of the second EA modulator (n-type semiconductor layer)

In the case where the polarity is reversed, a positive DC bias voltage is applied to the n-type electrode of the first EA modulator (n-type semiconductor layer) and a negative DC bias voltage is applied to the p-type electrode of the second EA modulator (p-type semiconductor layer).

In Embodiments 1 to 3, the n-type semiconductor layer, the modulation layer or the active layer, and the p-type semiconductor layer are crystal-grown in this order above the semi-insulating substrate. However, the order of stacking may be reversed and the p-type semiconductor layer, the modulation layer or the active layer, and the n-type semiconductor layer may be crystal-grown in this order above the semi-insulating substrate. In this case, replace “p-type” with “n-type” and “n-type” with “p-type” in Embodiments 1 to 3. Even if the order of stacking is reversed, the same forward voltage is applied to the p-n junction of the semiconductor laser, and the same reverse voltage is applied to the p-n junction of the electro-absorption type modulators.

### Embodiment 6

### <Configuration of Optical Modulator Integrated Semiconductor Laser and Optical Module According to Embodiment 6>

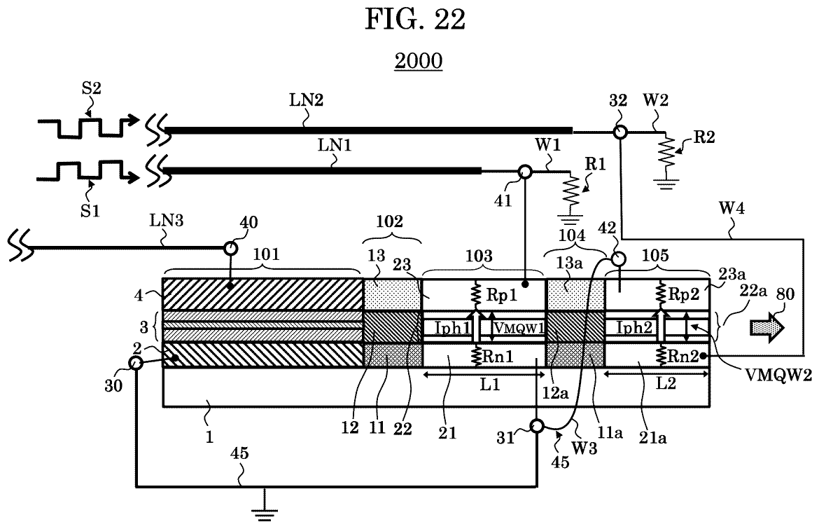

FIG. 22 is a cross-sectional view showing a device structure of an optical modulator integrated semiconductor laser 2000 according to Embodiment 6. FIG. 22 also shows the state of the wiring to the optical modulator integrated semiconductor laser 2000. In Embodiment 1, the length L1 of the first EA modulator section 103 along the optical waveguide direction is the same as the length L2 of the first EA modulator section 103 along the optical waveguide direction, whereas in the optical modulator integrated semiconductor laser 2000 according to Embodiment 6, setting L1>L2. The other structures are the same as Embodiment 1.

### <Operation of Optical Modulator Integrated Semiconductor Laser According to Embodiment 6>

The operation of the optical modulator integrated semiconductor laser 2000 according to Embodiment 6 is explained below referring to FIG. 22. The laser light emitted from the semiconductor laser section 101 is absorbed and attenuated in the first EA modulator section 103 before being incident on the second EA modulator section 105, so that the light intensity (first EA modulator)>light intensity (second EA modulator). That is, when Iph1 and Iph2 are the photocurrents generated by light absorption in the first EA modulator section 103 and the second EA modulator section 105, respectively, Iph1>Iph2.

In Embodiment 1, it is assumed that the difference in the amount of light incident on the first EA modulator section 103 and the second EA modulator section 105 is small, that is, the difference between Iph1 and Iph2 is small. On the other hand, if the difference between Iph1 and Iph2 is large, the influence of the voltage drop due to the photocurrents needs to be taken into account.

As shown in FIG. 22, the first EA modulator section 103 has a series resistance (Rp1+Rn1) consisting of a p-type semiconductor layer resistance Rp1 and an n-type semiconductor layer resistance Rn1. The second EA modulator section 105 also has a series resistance (Rp2+Rn2) in the same way. In the case where the photocurrent is large, the voltage drop due to the series resistance (=photocurrent×series resistance) also is large, so that the voltage applied to the modulation layer of the EA modulator is small. Here, the voltage applied to the modulation layer is the sum of the DC bias voltage component and the modulation voltage component.

In the case where the frequency response bandwidth of the EA modulator is sufficiently secured, that is, in the case where the frequency response bandwidth is generally 70% or more of the modulation speed, the maximum effect of cancelling out fluctuations in light intensity due to electromagnetic interference is achieved when the extinction ratio of the first EA modulator section 103 and the second EA modulator section 105 is equal.

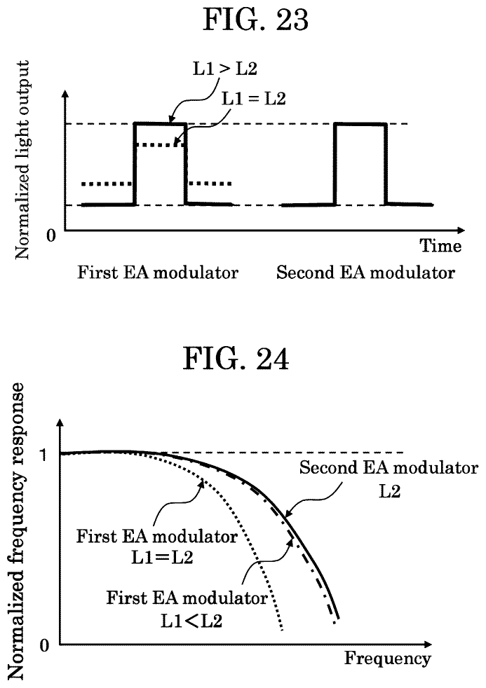

On the other hand, in the case where the photocurrent Iph1 flowing through the first EA modulator section 103 is larger than the photocurrent Iph2 flowing through the second EA modulator section 105, then due to the voltage drop caused by the series resistance, the modulation voltage component of the voltage Vmqw1 applied to the first modulation layer 22 of the first EA modulator section 103 is smaller than the modulation voltage component of the voltage VMWQ2 applied to the second modulation layer 22a of the second EA modulator section 105. Therefore, in the case where Iph1>Iph2 and the lengths of the two EA modulators are the same (L1=L2), as shown in FIG. 23, the extinction ratio of the first EA modulator section 103 is smaller than that of the second EA modulator section 105.

Therefore, by making the length L1 of the first EA modulator section 103 longer than the length L2 of the second EA modulator section 105, that is, by setting L1>L2, it is possible to adjust the extinction ratio of both to be equal, and thus to increase the effect of cancelling out fluctuations in light intensity. In addition, as a method for adjusting the extinction ratio of both, it is also possible to increase the extinction ratio of both by increasing the width of the first EA modulator section 103 wider than the width of the second EA modulator section 105 to increase the light confinement effect, thereby increasing the effect of cancelling out fluctuations in light intensity.

### Effects of Embodiment 6

As described above, according to the light modulator integrated semiconductor laser of Embodiment 6, the extinction ratio of the first EA modulator section 103 and the second EA modulator section 105 can be adjusted to the same level by making the length L1 of the first EA modulator section 103 longer than the length L2 of the second EA modulator section 105, or by making the width of the first EA modulator section 103 wider than the width of the second EA modulator section 105. As a result, even if the light intensity passing through the first EA modulator section 103 fluctuates due to electromagnetic interference, the second EA modulator section 105 cancels out this fluctuation in light intensity, so that the influence of electromagnetic interference on the light emitted from the optical modulator integrated semiconductor laser can be suppressed. In addition, it also has the effect of providing an optical modulator integrated semiconductor laser that enables broadband optical transceiver, high-density mounting and simplification of error rate correction circuits.

### Modification 1 of Embodiment 6

### <Configuration of Optical Modulator Integrated Semiconductor Laser and Optical Module According to Modification 1 of Embodiment 6>

In the optical modulator integrated semiconductor laser 2000 according to Embodiment 6, the length L1 of the first EA modulator section 103 is longer than the length L2 of the second EA modulator section 105, that is, L1>L2. Meanwhile, in the optical modulator integrated semiconductor laser according to Modification 1 of Embodiment 6, the length L1 of the first EA modulator section 103 is set to be smaller than the length L2 of the second EA modulator section 105, that is, L1<L2. The other structure is the same as that of Embodiment 1.

### <Operation of Optical Modulator Integrated Semiconductor Laser According to Modification 1 of Embodiment 6>

In the case where the frequency response bandwidth of the EA modulator cannot be sufficiently secured, the maximum effect of cancelling out fluctuations of the optical power due to electromagnetic interference is achieved when the frequency response bands of the first EA modulator section 103 and the second EA modulator section 105 are equal. Since the photocurrent Iph1 flowing through the first EA modulator section 103 is larger than the photocurrent Iph2 flowing through the second EA modulator section 105, a voltage drop due to the series resistance occurs in the first EA modulator section 103, and the DC bias voltage shifts toward 0 V. Therefore, the DC bias voltage component of the voltage VMQW1 applied to the first modulation layer 22 of the first EA modulator section 103 is smaller than the DC bias voltage component of the voltage VMQW2 applied to the second modulation layer 22a of the second EA modulator section 105.

As a result, the depletion layer thickness of the first EA modulator section 103 becomes smaller than the depletion layer thickness of the second EA modulator section 105. When the depletion layer thickness of the first EA modulator section 103 decreases, the electrical capacitance increases, and the frequency response bandwidth decreases, causing a problem. That is, if the voltage drop due to the photocurrent is large and Iph1>Iph2, and the length of the first EA modulator section 103 and the length of the second EA modulator section 105 are equal, that is, L1=L2, as shown in FIG. 24, the frequency response of the first EA modulator section 103 is lower than that of the second EA modulator section 105.

In this case, that is, in the case where Iph1>Iph2, the length L1 of the first EA modulator section 103 is set to be shorter than the length L2 of the second EA modulator section 105 to reduce the electric capacitance of the first EA modulator section 103, thereby the frequency response bandwidth of the first EA modulator section 103 can be adjusted equally to the frequency response bandwidth of the second EA modulator section 105 as in the case of L1<L2 shown in FIG. 24.

As a result, even if the light intensity passing through the first EA modulator section 103 fluctuates due to electromagnetic interference, the second EA modulator section 105 can cancel out this fluctuation in light intensity, thereby enhancing the effect of reducing the fluctuation in light intensity. In addition, the adjustment of the frequency response bandwidth can also be achieved by reducing the electrical capacitance by setting the width of the first EA modulator section 103 to be smaller than the width of the second EA modulator section 105.

### Effects of Modification 1 of Embodiment 6

As described above, according to the optical modulator integrated semiconductor laser of Modification 1 of Embodiment 6, the length L1 of the first EA modulator section 103 along the optical waveguide direction is set to be smaller than the length L2 of the second EA modulator section 105 along the optical waveguide direction, or by setting the width of the first EA modulator section 103 smaller than the width of the second EA modulator section 105, the frequency response characteristics of both can be adjusted to be equal. As a result, even if the light intensity passing through the first EA modulator section 103 fluctuates due to electromagnetic interference, the second EA modulator section 105 cancels out this fluctuation in light intensity, thereby the influence of electromagnetic interference on the light emitted from the optical modulator integrated semiconductor laser can be suppressed. In addition, it also has the effect of providing an optical modulator integrated semiconductor laser that enables broadband optical transceiver, high-density mounting and simplification of error rate correction circuits.

As in Embodiment 6 and Modification 1 of Embodiment 6, the relative sizes of the lengths and the widths of the first EA modulator section 103 and the second EA modulator section 105 can be determined as appropriate, taking into account the effect of cancelling fluctuations in light intensity, and depending on whether the effect of adjusting the frequency response bandwidth or the extinction ratio is given priority.

### Modification 2 of Embodiment 6

### <Configuration of Optical Modulator Integrated Semiconductor Laser and Optical Module According to Modification 2 of Embodiment 6>

It is also possible to adjust the frequency response bandwidth and the extinction ratio by changing the layer structure of the first EA modulator section 103 and the second EA modulator section 105. As explained in Embodiment 1, the first modulation layer 22 of the first EA modulator section 103 comprises an i-type multi-quantum well layer with a carrier concentration of 5×10¹⁷ cm⁻³ or less and optical confinement layers formed above and below the multi-quantum well layer. By increasing the thickness of the i-type multi-quantum well layer of the first modulation layer 22 and thus reducing the electrical capacitance, it is possible to adjust the frequency: response bandwidth of the first EA modulator section 103. On the other hand, it is also possible to adjust the extinction ratio by increasing the optical confinement layer thickness and the well layer thickness of the multi-quantum well layer of the first modulation layer 22 of the first EA modulator section 103 to increase the amount of optical absorption in the first EA modulator section 103.

As a result, even if the light intensity passing through the first EA modulator section 103 fluctuates due to electromagnetic interference, the second EA modulator section 105 cancels out this fluctuation in light intensity, thereby the influence of electromagnetic interference on the light emitted from the optical modulator integrated semiconductor laser can be suppressed.

### Modification 3 of Embodiment 6

### <Configuration of Optical Modulator Integrated Semiconductor Laser and Optical Module According to Modification 3 of Embodiment 6>

In the first connecting waveguide section 102 and the second connecting waveguide section 104, it is also possible to adjust the frequency response bandwidth and the extinction ratio by changing the waveguide structure from one another. Here, changing the waveguide structure from one another means changing the waveguide width, layer thickness, center position of the waveguide, taper shape of the waveguide, and layer structure of the waveguide from one another.

The adjustment of the frequency response bandwidth can be achieved by increasing the carrier concentration of the second lower cladding layer 11a or the second upper cladding layer 13a of the second connecting waveguide 104 on the side of the second EA modulator section 105, by impurity diffusion or other means, thereby lowering the frequency response bandwidth of the second EA modulator section 105 and thus it is possible to match the frequency response bandwidth of the second EA modulator section 105 with the frequency response the first EA modulator section 103, which has decreased due to the large photocurrent. This is because when the carrier concentration of the second lower cladding layer 11a or the second upper cladding layer 13a increases, it acts as a parasitic capacitance of the second EA modulator section 105. This parasitic capacitance can also be adjusted by changing either or both the width and the length of the connecting waveguide sections.

The extinction ratio is adjusted by making the thickness of the second lower cladding layer 11a of the second connecting waveguide section 104 thicker than the thickness of the first lower cladding layer 11 of the first connecting waveguide section 102 and thus raising the center position of the optical propagation mode. In this case, the position of the light incident on the second EA modulator section 105 is higher than the center of the second modulation layer 22a, thereby the extinction ratio of the second EA modulator section 105 is lowered, enabling the extinction ratio of the first EA modulator section 103 to be matched.

That is, even if the frequency response bandwidth or the extinction ratio of the first EA modulator section 103 and the second EA modulator section 105 differs due to the influence of the photoelectric current, it is possible to adjust the extinction ratio by changing the waveguide width, impurity concentration, and layer structure of the first connecting waveguide section 102 and the second connecting waveguide section 104. As a result, even if the light intensity passing through the first EA modulator section 103 fluctuates due to electromagnetic interference, the second EA modulator section 105 cancels out this fluctuation in light intensity, thereby the influence of electromagnetic interference on the light emitted from the optical modulator integrated semiconductor laser can be suppressed.

In addition, since the connecting waveguide has a function for shaping the light that is guided, it is possible to reduce the coupling loss of the light by making the first connecting waveguide section 102 or the second connecting waveguide section 104 tapered shapes in which the waveguide width gradually changes. For example, the propagation mode shape of the light differs between the semiconductor laser section 101 and the first EA modulator section 103, and therefore the half-width of the light also differs. However, the tapered shape of the first connecting waveguide section 102 allows the light emitted from the semiconductor laser section 101 to be converted into a mode shape and half-width suitable for propagating through the first EA modulator section 103, thereby reducing the optical coupling loss. Specifically, the waveguide width of the first connecting waveguide section 102 is gradually narrowed from the semiconductor laser section 101 side to the first EA modulator section 103 side, resulting in an effect of reducing the coupling loss.

### Modification 4 of Embodiment 6

### <Configuration of Optical Modulator Integrated Semiconductor Laser and Optical Module According to Modification 3 of Embodiment 6>

When the terminating resistor is increased in the EA modulator, the CR time constant increases, the frequency response bandwidth decreases, and at the same time, the impedance at the terminating side increases, thereby increasing the modulation voltage amplitude. Therefore, as a method of adjusting the frequency response bandwidth and the extinction ratio, it is also effective to change e the resistance value of the respective terminating resistors connected to the first EA modulator section 103 and the second EA modulator section 105.

As shown in FIG. 22, the first terminating resistor R1 is connected to the first EA modulator section 103, and the second terminating resistor R2 is connected to the second EA modulator section 105. In the case where the influence of photocurrent is not considered, R1=R2, in which the frequency response bandwidth and the extinction ratio of the two EA modulators are the same, is considered to be optimal in order to cancel out and reduce fluctuations in light intensity due to electromagnetic interference or the like by the two EA modulators.

On the other hand, in the case where the photoelectric current flows in each EA modulator, in the case where the lengths of the two EA modulators are not equal, or in the case where the waveguide widths of the first connecting waveguide section 102 and the second connecting waveguide section 104 are different, the frequency response bandwidths and the extinction ratios of the two EA modulators may not be the same.

In this case, by setting R1>R2, it is possible to reduce the frequency response bandwidth of the first EA modulator section 103 and thus increase the extinction ratio thereof. Conversely, by setting R1<R2, it is also possible to reduce the frequency response bandwidth of the second EA modulator section 105 and thus increase the extinction ratio thereof.

As described above, by making the first terminating resistor R1 and the second terminating resistor R2 have different resistance values, it is possible to adjust and align the frequency response bandwidths and the extinction ratios of the two EA modulators. As a result, even if the light intensity passing through the first EA modulator section 103 fluctuates due to electromagnetic interference, the second EA modulator section 105 can cancel out this fluctuation in light intensity, thereby suppressing the influence of electromagnetic interference on the light emitted from the optical modulator integrated semiconductor laser.

The respective resistance values of the first terminating resistor R1 and the second terminating resistor R2 are preferably in a range of 25Ω or more and 100Ω or less, corresponding to half to twice the reference value of 50Ω. This is because the electric reflection increases outside the numerical range and thus the fluctuation in light intensity increases.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

1 semi-insulating substrate
1a Fe-doped InP substrate
2 n-type cladding layer
2a n-type InGaAsP conductive layer
2b n-type InP cladding layer
3 active layer
4 p-type cladding layer
4a p-type InP cladding layer
4b p-type InGaAs contact layer
5 insulating protection film
6 current blocking layer
6a buried semiconductor layer
11 first lower cladding layer
11a second lower cladding layer
11d InP third lower cladding layer
12 first waveguide layer
12a second waveguide layer
12d InGaAsP third waveguide layer
13 first upper cladding layer
13a second upper cladding layer
13d InP third upper cladding layer
21 n-type first semiconductor layer
21a n-type second semiconductor layer
21c n-type InGaAsP first conductive layer
21e n-type InGaAsP second conductive layer
21d n-type InP first cladding layer
21f n-type InP second cladding layer
22 first modulation layer
22a second modulation layer
23 p-type first semiconductor layer
23a p-type second semiconductor layer
23c p-type InP first cladding layer
23e p-type InP second cladding layer
23d p-type InGaAs first contact layer
23f p-type InGaAs second contact layer
30 n-type electrode of semiconductor laser section
31 n-type electrode of first EA modulator
32 n-type electrode of second EA modulator
40 p-type electrode of semiconductor laser section
41 p-type electrode of first EA modulator
42 p-type electrode of second EA modulator
45, 45b first common electrode
45a second common electrode
48, 48a, 49 grounding electrode
51 wire bonding pad for first common electrode
52 wire bonding pad for p-type electrode of first EA modulator
53 wire bonding pad for n-type electrode of second EA modulator
54 wire bonding pad for n-type electrode of first EA modulator
55 through electrode
61 waveguide conversion section
80 modulated light
83 incident light
84 radiation mode
90 monitor PD
91 optical lens system
92 wavelength multiplexer
93 optical fiber
101 semiconductor laser section
102 first connecting waveguide section
103 first EA modulator section
104 second connecting waveguide section
105, 105a, 105b, 105c second EA modulator section
106 waveguide lens section
200 mounting substrate
201 wiring substrate
500, 600, 700, 760, 800, 810, 820, 900, 910, 1604, 1703, 1803 optical modulator integrated semiconductor laser
920 optical modulator
1000, 1010, 1020, 1030, 1040, 1100, 1110, 1120, 1130 optical module
1500 optical transmission unit of transceiver
1600 multi-level intensity modulation transceiver
1601, 1705, 1805 DSP
1602a, 1602b ADC
1603, 1702, 1802 driver amplifier
1610, 1710, 1810 optical fiber cable
1605 PD
1606 linear-TIA
1700, 1800 optical line terminating device
1701, 1801 FEC
1704, 1804 WDM
1706, 1806 ADC
1707 burst TIA
1708, 1808 APD
1807 TIA
LN1, La1 first modulation signal line
LN2, La2 second modulation signal line
LN3, La3 semiconductor laser section current line
LN5 line
Lg10, Lg11 ground line
R1 first terminating resistor
R2 second terminating resistor
R3 third terminating resistor
S1 first modulation signal
S2 second modulation signal
W1, W2, W3, Wc1, Wc2, Wg1, Wg2, Wg3, Wg10, Wg11, Wr1, Wr2 wire
Ws1, Ws2 wire bond space

What is claimed is:

1. An optical modulator integrated semiconductor laser comprising:
a semi-insulating substrate;
a semiconductor laser section formed on the semi-insulating substrate and including at least an n-type cladding layer, an active layer, and a p-type cladding layer;
a first connecting waveguide section formed on the semi-insulating substrate and including at least a first lower cladding layer, a first waveguide layer, and a first upper cladding layer;
a first EA modulator section formed on the semi-insulating substrate and including at least an n-type first semiconductor layer, a first modulation layer, a p-type first semiconductor layer, an n-type electrode of a first EA modulator electrically connected to the n-type first semiconductor layer, and a p-type electrode of the first EA modulator electrically connected to the p-type first semiconductor layer;
a second connecting waveguide section formed on the semi-insulating substrate and including at least a second lower cladding layer, a second waveguide layer, and a second upper cladding layer;
a second EA modulator section formed on the semi-insulating substrate and including at least an n-type second semiconductor layer, a second modulation layer, a p-type second semiconductor layer, an n-type electrode of a second EA modulator electrically connected to the n-type second semiconductor layer, and a p-type electrode of the second EA modulator electrically connected to the p-type second semiconductor layer; and
a first common electrode electrically connected to the n-type electrode of the first EA modulator and the p-type electrode of the second EA modulator.

2. The optical modulator integrated semiconductor laser according to claim 1, wherein
the first common electrode functions as a ground electrode.

3. The optical modulator integrated semiconductor laser according to claim 1, wherein
the p-type electrode of the first EA modulator electrically connected to a first modulation signal line for transmitting a first modulation signal, and the n-type electrode of the second EA modulator electrically connected to a second modulation signal line for transmitting a second modulation signal composed of a signal in the opposite phase to the first modulation signal.

4. An optical modulator integrated semiconductor laser comprising:
a semi-insulating substrate;
a semiconductor laser section formed on the semi-insulating substrate and including at least an n-type cladding layer, an active layer, and a p-type cladding layer;
a first connecting waveguide section formed on the semi-insulating substrate and including at least a first lower cladding layer, a first waveguide layer, and a first upper cladding layer;
a first EA modulator section formed on the semi-insulating substrate and including at least an n-type first semiconductor layer, a first modulation layer, a p-type first semiconductor layer, an n-type electrode of a first EA modulator electrically connected to the n-type first semiconductor layer, and a p-type electrode of the first EA modulator electrically connected to the p-type first semiconductor layer;
a second connecting waveguide section formed on the semi-insulating substrate and including at least a second lower cladding layer, a second waveguide layer, and a second upper cladding layer;
a second EA modulator section formed on the semi-insulating substrate and including at least an n-type second semiconductor layer, a second modulation layer, semiconductor layer, an n-type a p-type second electrode of a second EA modulator electrically connected to the n-type second semiconductor layer, and a p-type electrode of the second EA modulator electrically connected to the p-type second semiconductor layer; and
a second common electrode electrically connecting the p-type electrode of the first EA modulator and the n-type electrode of the second EA modulator.

5. The optical modulator integrated semiconductor laser according to claim 4,
wherein the second common electrode functions as a ground electrode.

6. The optical modulator integrated semiconductor laser according to claim 4, wherein
the n-type electrode of the first EA modulator is electrically connected to a first modulation signal line for transmitting a first modulation signal, and the p-type electrode of the second EA modulator is electrically connected to a second modulation signal line for transmitting a second modulation signal composed of a signal in the opposite phase to the first modulation signal.

7. The optical modulator integrated semiconductor laser according to claim 1, wherein
the semiconductor laser section has a buried waveguide, and
the first EA modulator section, the second connecting waveguide section, and the second EA modulator section have a high-mesa waveguide and
the buried waveguide is converted to the high-mesa waveguide in the first connecting waveguide section.

8. The optical modulator integrated semiconductor laser according to claim 1, wherein
the semiconductor laser section has a buried waveguide, and
the first EA modulator section, the second connecting waveguide section, and the second EA modulator section have a low-mesa waveguide and
the buried waveguide is converted to the low-mesa waveguide in the first connecting waveguide section.

9. The optical modulator integrated semiconductor laser according to claim 1, wherein
the semiconductor laser section has a low-mesa waveguide, and
the first EA modulator section, the second connecting waveguide section, and the second EA modulator section have a high-mesa waveguide, and
the low-mesa waveguide is converted to the high-mesa waveguide in the first connecting waveguide section.

10. The optical modulator integrated semiconductor laser according to claim 1, wherein
the semiconductor laser section, the first EA modulator section, the second connecting waveguide section, and the second EA modulator section all have a low-mesa waveguide.

11. The optical modulator integrated semiconductor laser according to claim 1, further comprising:
a wire bonding pad for the p-type electrode of the first EA modulator electrically connected to the p-type electrode of the first EA modulator, the wire bonding pad for the p-type electrode of the first EA modulator being located on one side of a reference line on which the semiconductor laser section, the first connecting waveguide section, the first EA modulator section, the second connecting waveguide section, and the second EA modulator section are sequentially arranged along the optical waveguide direction in a plan view;
a wire bonding pad for the n-type electrode of the second EA modulator that is located on the one side of the reference line and is electrically connected to the n-type electrode of the second EA modulator; and
a wire bonding pad for the first common electrode that is located on the other side of the reference line and is electrically connected to the first common electrode.

12. The optical modulator integrated semiconductor laser according to claim 4, further comprising:
a wire bonding pad for the n-type electrode of the first EA modulator electrically connected to the n-type electrode of the first EA modulator, the wire bonding pad for the n-type electrode of the first EA modulator being located on one side of a reference line on which the semiconductor laser section, the first connecting waveguide section, the first EA modulator section, the second connecting waveguide section, and the second EA modulator section are sequentially arranged along the optical waveguide direction in a plan view;
a wire bonding pad for the p-type electrode of the second EA modulator that is located on the one side of the reference line and is electrically connected to the p-type electrode of the second EA modulator; and
a wire bonding pad for the second common electrode that is located on the other side of the reference line and is electrically connected to the second common electrode.

13. The optical modulator integrated semiconductor laser according to claim 11, further comprising:
an n-type electrode of the semiconductor laser section electrically connected to the n-type cladding layer of the semiconductor laser section;
a wire bonding pad for the n-type electrode of the semiconductor laser section that is located on the same side as the wire bonding pad for the first common electrode with respect to the reference line and is electrically connected to the n-type electrode of the semiconductor laser section.

14. The optical modulator integrated semiconductor laser according to claim 12, further comprising:
an n-type electrode of the semiconductor laser section electrically connected to the n-type cladding layer of the semiconductor laser section;
a wire bonding pad for the n-type electrode of the semiconductor laser section that is located on the same side as the wire bonding pad for the second common electrode with respect to the reference line and is electrically connected to the n-type electrode of the semiconductor laser section.

15. The optical modulator integrated semiconductor laser according to claim 13, wherein
the n-type electrode of the semiconductor laser section is electrically connected to the first common electrode.

16. The optical modulator integrated semiconductor laser according to claim 14, wherein
the n-type electrode of the semiconductor laser section is electrically connected to the second common electrode.

17. The optical modulator integrated semiconductor laser according to claim 11, wherein
the wire bonding pad for the first common electrode includes: a first wire bonding pad portion provided closer to the end surface of the semiconductor laser section than the wire bonding pad for the p-type electrode of the first EA modulator; and a second wire bonding pad portion provided closer to the output end surface than the wire bonding pad for the n-type electrode of the second EA modulator.

18. The optical modulator integrated semiconductor laser according to claim 12, wherein
the wire bonding pad for the second common electrode includes: a third wire bonding pad portion provided closer to the end surface of the semiconductor laser section than the wire bonding pad for the n-type electrode of the first EA modulator; and a fourth wire bonding pad portion provided closer to the output end surface than the wire bonding pad for the p-type electrode of the second EA modulator.

19. An optical module comprising:
a mounting substrate;
the optical modulator integrated semiconductor laser according to claim 11 that is located on the mounting substrate;
a first modulation signal line provided on the mounting substrate and electrically connected to the wire bonding pad for the p-type electrode of the first EA modulator through a wire; and
a second modulation signal line provided on the mounting substrate and electrically connected to the wire bonding pad for the n-type electrode of the second EA modulator through a wire, wherein
the first modulation signal line and the second modulation signal line are arranged on the same side as the wire bonding pad for the p-type electrode of the first EA modulator and the wire bonding pad for the n-type electrode of the second EA modulator with respect to a reference line along the center of the optical modulator integrated semiconductor laser with respect to the optical modulator integrated semiconductor laser as a reference.

20. An optical module comprising:
a mounting substrate;
the optical modulator integrated semiconductor laser according to claim 12 that is located on the mounting substrate;
a first modulation signal line provided on the mounting substrate and electrically connected to the wire bonding pad for the n-type electrode of the first EA modulator through a wire; and
a second modulation signal line provided on the mounting substrate and electrically connected to the wire bonding pad for the p-type electrode of the second EA modulator through a wire, wherein
the first modulation signal line and the second modulation signal line are arranged on the opposite side of the wire bonding pad for the n-type electrode of the first EA modulator and the wire bonding pad for the p-type electrode of the second EA modulator with respect to a reference line along the center of the optical modulator integrated semiconductor laser with respect to the optical modulator integrated semiconductor laser as a reference.

21. The optical module according to claim 19, further comprising:
a first terminating resistor electrically connected to the wire bonding pad for the p-type electrode of the first EA modulator; and
a second terminating resistor electrically connected to the wire bonding pad for the n-type electrode of the second EA modulator, wherein
a first terminating resistor and a second terminating resistor are arranged on the opposite side of the wire bonding pad for the p-type electrode of the first EA modulator and the wire bonding pad for the n-type electrode of the second EA modulator with respect to the reference line along the center of the optical modulator integrated semiconductor laser with respect to the optical modulator integrated semiconductor laser as a reference.

22. The optical module according to claim 20, further comprising:
a first terminating resistor electrically connected to the wire bonding pad for the n-type electrode of the first EA modulator; and
a second terminating resistor electrically connected to the wire bonding pad for the p-type electrode of the second EA modulator, wherein
the first terminating resistor and the second terminating resistor are arranged on the same side as the wire bonding pad for the n-type electrode of the first EA modulator and the wire bonding pad for the p-type electrode of the second EA modulator with respect to a reference line along the center of the optical modulator integrated semiconductor laser with respect to the optical modulator integrated semiconductor laser as a reference.

23. The optical module according to claim 19, wherein
the n-type electrode of the first EA modulator and the p-type electrode of the second EA modulator are electrically connected to a grounding electrode provided on the mounting substrate and grounded either DC or AC.

24. The optical module according to claim 20, wherein
the p-type electrode of the first EA modulator and the n-type electrode of the second EA modulator are electrically connected to a grounding electrode provided on the mounting substrate and grounded either DC or AC.

25. The optical module according to claim 19, further comprising:
a first terminating resistor; a second terminating resistor; and a grounding electrode, which are located on the mounting substrate, wherein
the first modulation signal line, the wire bonding pad for the p-type electrode of the first EA modulator, the first terminating and the grounding electrode are electrically connected in this order, and the second modulation signal line, the wire bonding pad for the n-type electrode of the second EA modulator, the second terminating resistor, and the grounding electrode are electrically connected in this order.

26. The optical module according to claim 20, further comprising:
a first terminating resistor; a second terminating resistor; and a grounding electrode, which are located on the mounting substrate, wherein
the first modulation signal line, the wire bonding pad for the n-type electrode of the first EA modulator, the first terminating resistor, and the grounding electrode are electrically connected in this order, and the second modulation signal line, the wire bonding pad for the p-type electrode of the second EA modulator, the second terminating resistor, and the grounding electrode are electrically connected in this order.

27. The optical module according to claim 23, further comprising:
a first ground line provided on the opposite side of the second modulation signal line with respect to the first modulation signal line as a reference;
a second ground line provided on the opposite side of the first modulation signal line with respect to the second modulation signal line as a reference; and
a grounding electrode provided on the opposite side of the first modulation signal line with respect to the optical modulator integrated semiconductor laser as a reference, wherein
the first ground line, the n-type electrode of the first EA modulator, and the grounding electrode are electrically connected in this order, and the second ground line, the p-type electrode of the second EA modulator, and the grounding electrode are electrically connected in this order.

28. The optical module according to claim 24, further comprising:
a first ground line provided on the opposite side of the second modulation signal line with respect to the first modulation signal line as a reference;
a second ground line provided on the opposite side of the first modulation signal line with respect to the second modulation signal line as a reference; and
a grounding electrode provided on the opposite side of the first modulation signal line with respect to the optical modulator integrated semiconductor laser as a reference, wherein
the first ground line, the p-type electrode of the first EA modulator, and the grounding electrode are electrically connected in this order, and the second ground line, the n-type electrode of the second EA modulator, and the grounding electrode are electrically connected in this order.

29. The optical module according to claim 25, wherein
the first capacitor is arranged in series between the first terminating resistor and the grounding electrode, or between the first terminating resistor and the wire bonding pad for the p-type electrode of the first EA modulator, and the second capacitor is arranged in series between the second terminating resistor and the grounding electrode, or between the second terminating resistor and the wire bonding pad for the n-type electrode of the second EA modulator.

30. The optical module according to claim 26, wherein
the first capacitor is arranged in series between the first terminating resistor and the grounding electrode, or between the first terminating resistor and the wire bonding pad for the n-type electrode of the first EA modulator, and the second capacitor is arranged in series between the second terminating resistor and the grounding electrode, or between the second terminating resistor and the wire bonding pad for the p-type electrode of the second EA modulator.

31. The optical module according to claim 19, wherein
the first modulation signal line is electrically connected to the wire bonding pad for the p-type electrode of the first EA modulator, and the second modulation signal line is electrically connected to the wire bonding pad for the n-type electrode of the second EA modulator, and the wire bonding pad for the p-type electrode of the first EA modulator and the wire bonding pad for the n-type electrode of the second EA modulator are electrically connected through a third terminating resistor.

32. The optical module according to claim 20, wherein
the first modulation signal line is electrically connected to the wire bonding pad for the n-type electrode of the first EA modulator, and the second modulation signal line is electrically connected to the wire bonding pad for the p-type electrode of the second EA modulator, and the wire bonding pad for the n-type electrode of the first EA modulator and the wire bonding pad for the p-type electrode of the second EA modulator are electrically connected through a third terminating resistor.

33. The optical module according to claim 31, wherein
the third capacitor is electrically connected in series between the wire bonding pad for the p-type electrode of the first EA modulator and the third terminating resistor, or between the wire bonding pad for the n-type electrode of the second EA modulator and the third terminating resistor.

34. The optical module according to claim 32, wherein
the third capacitor is electrically connected in series between the wire bonding pad for the n-type electrode of the first EA modulator and the third terminating resistor, or between the wire bonding pad for the p-type electrode of the second EA modulator and the third terminating resistor.

35. A multi-level intensity modulation transceiver comprising:
a digital signal processing circuit for generating a multi-level intensity modulated digital signal on a basis of an input data signal;
an analog-to-digital conversion circuit for converting the digital signal into an analog modulation signal;
an amplifier circuit for amplifying the analog modulation signal;
the optical modulator integrated semiconductor laser according to claim 1 for inputting the amplified analog modulation signal; and
an optical system for coupling a modulation signal emitted from the optical modulator integrated semiconductor laser to an optical fiber.

36. An optical line terminating device comprising:
a forward error correction circuit for correcting a data error on a basis of an input data signal;
an amplifier circuit for amplifying an electric signal;
the optical modulator integrated semiconductor laser according to claim 1 for receiving the amplified electric signal; and
an optical system for coupling a modulation signal emitted from the optical modulator integrated semiconductor laser to an optical fiber.
